(19) United States
(12) Patent Application Publication
(10) Pub. No.: US 2008/0205617 A1
(43) Pub. Date: Aug. 28, 2008

(54) CALL CONNECTION PROGRAM, CALL CONNECTION METHOD AND CALL CONNECTOR

(75) Inventors: Iwao Sugawara, Kawasaki (JP); Soichi Nishiyama, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 12/035,142

(22) Filed: Feb. 21, 2008

(30) Foreign Application Priority Data
Feb. 28, 2007 (JP) 2007-49734

(51) Int. Cl. H04M 3/42

(52) U.S. Cl. 379/211.02

(57) ABSTRACT

A call connector and method thereof controlling a call connection between a telephone of a connection service user and a telephone corresponding to a registered number of a user. The method includes searching for user information including a user connection number, user identification information and an actual phone number for directly connecting to the telephone of the user and extracting the user identification information corresponding to the user connection number and the actual phone number of the user, based on the user connection number responsive to a call connection request. The call connector includes specifying the actual phone number as a caller's phone number and the user connection number as a phone number of a connection request destination, extracting a dummy number and forwarding a call connection request specifying the user's actual phone number as a forwarding number and the dummy number as a caller.

### CROSS-REFERENCE TO RELATED APPLICATIONS

This application is related to and claims the benefit of priority from Japanese Patent Application No. 2007-49734, filed on Feb. 28, 2007, the entire contents of which are incorporated herein by reference.

### BACKGROUND

### Field

The present invention relates to a call connection program, a call connection method and a call connector, and, more particularly, to a call connection program, call connection method and call connector for controlling a call connection between a telephone used by a connection service user and a telephone registered by the user as a destination for telephonic communication.

### SUMMARY

The disclosed call connector and method thereof include controlling a call connection between a telephone of a connection service user and a telephone of a registered number registered by a user as a number for telephonic communication.

The call connector includes searching for user information including a user connection number, user identification information for identifying the user and an actual phone number for directly connecting to the telephone of the user, stored in association with each other. The user identification information corresponding to the user connection number and the actual phone number of the user is extracted, based on the user connection number, upon acquisition of a call connection request specifying the actual phone number as a caller's phone number and specifying the user connection number for connecting to the user's telephone through the connection service as a phone number of a connection request destination.

The disclosed method includes searching for telephone directory information including the actual phone number of the registered number stored and a dummy number assigned to the actual phone number of the registered number in association with the user identification information and extracting the dummy number of the registered number, based on the user identification information extracted and the actual phone number of the registered number of the caller.

The disclose call connection and method thereof include forwarding the call connection request, to the user's telephone, specifying the user's actual phone number extracted as a forwarding number and the dummy number of the registered number as a caller.

Additional aspects and/or advantages will be set forth in part in the description which follows and, in part, will be apparent from the description, or may be learned by practice of the invention.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 is a schematic diagram illustrating a system including a call connector;

FIG. 2 is a diagram illustrating a configuration of a secure telephone system;

FIG. 3 is a diagram illustrating a processing flow when a telephone call is made from a user's cell phone to a customer's phone;

FIG. 4 is a diagram illustrating a processing flow when a telephone call is made from a customer's phone to a user's cell phone;

FIG. 5 is a diagram illustrating a hardware configuration of a secure telephone directory management server;

FIG. 6 is a block diagram illustrating functions of a secure telephone directory system;

FIG. 7 is a diagram illustrating an example of user information which is stored in a user DB of a secure telephone system;

FIG. 8 is a diagram illustrating an example of a secure telephone directory which is stored in a secure telephone directory DB of a secure telephone system;

FIG. 9 is a diagram illustrating an example of dummy number information which is stored in a dummy number DB of a secure telephone system;

FIG. 10 is a diagram illustrating an example of a cell phone directory which is stored in a cell phone DB of a user's cell phone;

FIG. 11 is a workflow diagram illustrating process(es) in relation to when a secure telephone system receives a connection request specifying a user number with “050” as a connection destination until when telephonic communication begins;

FIG. 12 is a workflow diagram illustrating a number search process of FIG. 11;

FIG. 13 is a workflow diagram illustrating a forwarding process of FIG. 11;

FIG. 14 is a workflow diagram illustrating an operation in relation to when a caller's dummy number has not been registered in a secure telephone directory in FIG. 11;

FIG. 15 is a workflow diagram illustrating a number search process of FIG. 14;

FIG. 16 is a workflow diagram illustrating a forwarding process of FIG. 14;

FIG. 17 is a workflow diagram illustrating an operation in relation to when a caller's actual telephone number is unknown in FIG. 11;

FIG. 18 is a workflow diagram illustrating a number search process of FIG. 17;

FIG. 19 is a workflow diagram illustrating process(es) in relation to when a secure telephone system receives a connection specifying a dummy number as a connection destination until when telephonic communication begins;

FIG. 20 is a workflow diagram illustrating a number search process of FIG. 19;

FIG. 21 is a workflow diagram illustrating a forwarding process of FIG. 19;

FIG. 22 is a workflow diagram illustrating an operation in relation to when a callee's dummy number has not been registered in a secure telephone directory in FIG. 19;

FIG. 23 is a workflow diagram illustrating a number search process of FIG. 22;

FIG. 24 is a workflow diagram illustrating an operation in relation to when a callee's dummy number has not been registered in a secure telephone directory in FIG. 19;

FIG. 25 is a workflow diagram illustrating the number search process of FIG. 23;

FIG. 26A and FIG. 26B are diagrams each illustrating an example of a secure telephone directory registration screen;

FIG. 27 is a workflow diagram illustrating processes of a secure number directory registration process; and

FIG. 28 is a workflow diagram illustrating process(es) of a cell phone directory setting process.

### DETAILED DESCRIPTION OF THE PREFERRED EMBODIMENTS

Reference will now be made in detail to the embodiments, examples of which are illustrated in the accompanying drawings, wherein like reference numerals refer to the like elements throughout. The embodiments are described below to explain the present invention by referring to the figures.

In recent years, computers have been used for controlling call connection(s). Popular telephones connecting to a telephone line tend to be those that can easily provide services through a computer. Examples of such telephones are IP telephones that send and receive voice data through a network using an IP (Internet Protocol) and also cell phones that connect to a packet network to implement data communications.

One call connection service using a computer provides central management of telephone directories of cell phones using a database. A telephone directory function is one of the functions of each cell phone, and can store information representing other parties' names in association with telephone numbers in the cell phone for telephonic communication. If the cell phone passes to a third party's hands due to loss or robbery (theft), the registered information may possibly be revealed to the third party.

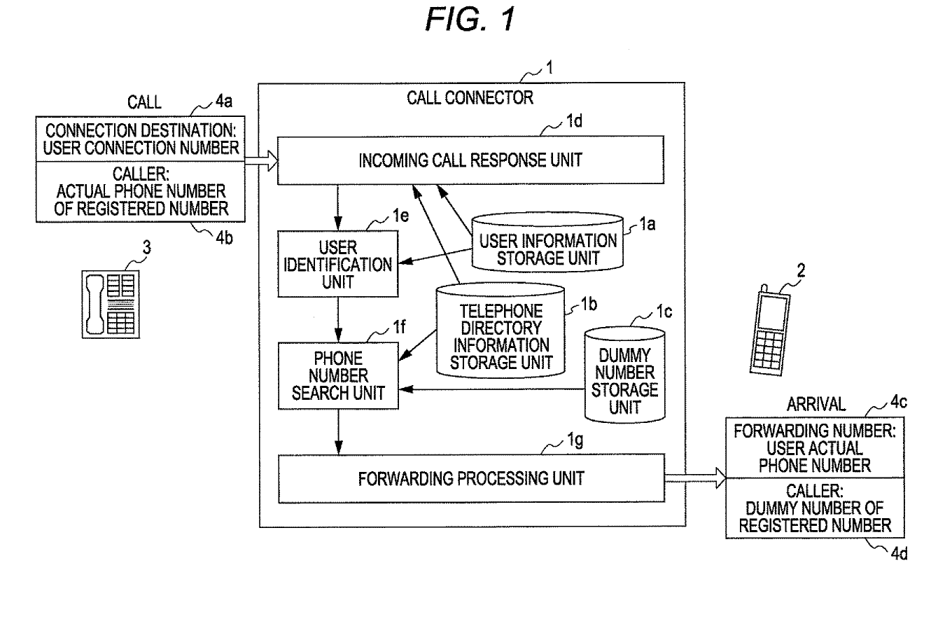

To overcome this problem, there is proposed a central management method for a telephone directory (see Japanese Patent Application Laid-Open (JP-A) 2003-37671 including FIG. 1, for example). According to this method, a database on a server stores a telephone directory having user IDs and phone numbers in association with each other. Upon reception of a request for a connection service from a cell phone, the server sends a list of user IDs to the cell phone as a requester. When a user ID selected from the list is given to the server from the cell phone, the server retrieves a phone number corresponding to the user ID. Then, the server connects a call from the cell phone to the destination phone number.

The telephone directory stored in the cell phone is used to verify the received phone number with the phone numbers registered in the telephone directory, thereby enabling display of a name corresponding to a phone number on the display as a caller in association the telephonic communication.

As long as the telephone directory is centrally managed by the database on the server, it is not necessary to store the telephone directory in the user's cell phone. However, since the telephone directory is not stored in the cell phone, the caller of the received phone number can not be specified. Therefore, according to typical techniques, it is not possible to achieve both the display of the caller name and prevention of leakage of the telephone directory information stored in the cell phone, for example, to a malicious third party.

Descriptions of the concept(s) of embodiment(s) of the present invention and specific contents thereof is provided in detail below.

FIG. 1 is a schematic diagram of a system including a call connector according to an embodiment.

A call connector 1 may comprise storage unit(s) such as a user information storage 1a, a telephone directory information storage 1b and a dummy number storage 1c, and processing units such as an incoming call response unit 1d, a user identification unit 1e, a phone number search unit 1f and a forwarding processing unit 1g. The call connector 1 provides a call connection service and controls call connection(s) between a user telephone 2 of a user of the call connection services and a registered telephone 3 that is a telephone used by a person who makes a telephone communication with the user. Each of the processing units may realize respective processing functions by a computer reading and executing call connection programs stored on a recording medium.

According to a call connection service, the call connector 1 forwards a connection request to a registered telephone, when a telephone of a first user who uses the service requests the call connector 1 to connect to a person for telephonic communication (hereinafter referred to as a registered number) registered in a telephone directory managed by the call connector 1. As a result, telephonic communication begins therebetween. The call connector 1 informs the telephone associated with a registered number about a user-connection number connectable through the connection service, as information regarding the caller. When a second user who uses the telephone associated with the registered number needs to contact the first user, the second user uses the telephone of the registered number to make a phone call to the informed user-connection number. The call connector 1 provides connection service(s) for forwarding the connection request received from the telephone associated with the registered number to the telephone of the first user. Descriptions will now mainly be made to a connection service from the telephone 3 associated with the registered number to the user's telephone 2.

Descriptions will now be made to each section of the call connector 1.

The user information storage 1a is a storage unit for storing user information regarding a user registered in advance by the user of the call connection service of the call connector 1. The user information includes information regarding actual phone number(s) for directly connecting to the user's telephone and a user connection number for a connection through the call connector 1, in association with user identification information for identifying the individual users. The actual phone number is a generally used phone number used for making a connection to the telephone of the user without having to use the call connector 1. The user connection number is a phone number used by the call connector 1 for processing, and is used for connecting to the user's telephone through the connection service of the call connector 1.

The telephone directory information storage 1b is a storage unit for storing the actual phone number of a person for telephonic communication (registered number) and a dummy number assigned to the registered actual telephone number, in association with the user identification information. The person for telephonic communication may be registered by the user corresponding to user identification information. The dummy number is information which is expressed in the same series of numbers as that of the phone number. Dummy number specification information may be set so that an arbitrary dummy number included in a plurality of dummy numbers stored in the dummy number storage 1c, without setting the dummy numbers directly in the telephone directory information. Normally, dozens or more than one hundred phone numbers of telephone numbers are registered in the phone directory for a single user. A considerable amount of information may result, if dummy numbers are set uniquely for the respective registered numbers. In this context, one single dummy number may be shared by a plurality of registered numbers (needless to say, the same dummy number will not be given to the registered numbers of the same user), thereby restraining an increase in the number of dummy numbers.

The dummy number storage 1c is a storage unit for storing dummy numbers in association with dummy number specification information of the telephone directory information.

Upon acquisition of a request for a call connection to the telephone 3 of the registered number from the user's telephone 2 or a request for a call connection to the user's telephone 2 from the telephone 3 of the registered number, the incoming call response unit 1d searches the user information storage 1a and the telephone directory information storage 1b, and determines whether the caller's phone number is a user's or the registered number, based on the caller's phone number. Then, the incoming call response unit 1d extracts the phone number of the connection destination and the phone number of the caller, and sends them to the user identification unit 1e. At the same time, the unit 1d executes a process including sending an indication that it is in a connection process to the caller.

The user identification unit 1e searches the user information storage 1a for user information based on a user connection number, when the incoming call response unit 1d acquires a connection request (call) which specifies the user connection number as a connection destination 4a and an actual phone number of the registered number as a caller 4b, from the telephone 3 of the registered number. The user identification unit 1e extracts the user identification information corresponding to the user connection number and the actual phone number of the user's telephone 2. The user identification unit 1e also sends the user identification information to the phone number search unit 1f, and outputs the user's actual phone number to the forwarding processing unit 1g.

The phone number search unit 1f searches the telephone directory information storage 1b for the telephone directory information, based on the user identification information extracted by the user identification unit 1e and the actual phone number of the registered number extracted by the incoming call response unit 1d. The phone number search unit 1f then extracts a dummy phone number of a registered number, based on information of this registered number corresponding to the user identification information. If this dummy number is dummy number specification information, the unit 1f searches the dummy number storage 1c for the dummy number information based on the dummy number specification information to extract a specified dummy number, and outputs the dummy phone number to the forwarding processing unit 1g.

In response to a connection request acquired by the incoming call response unit 1d, the forwarding processing unit 1g converts the connection destination into the actual phone number of the connection destination (telephone 2) extracted by the user identification unit 1e and also the caller to the dummy number of the registered number extracted by the phone number search unit 1f, and then forwards the converted information to the user's telephone 2.

While storing in FIG. 1 is described using specific storages, the present invention is not limited to any type or configuration of a storage unit. For example, storage functionality of the call connector 1 of FIG. 1 may include any type of temporary or permanent storage technology that is useable to retain data and may be provided as a separate component communicatively coupled to the call connector 1.

Descriptions will now be made to an operational method and call connection method for thus configured call connector 1.

Upon acquisition of a connection request specifying a user connection number as the connection destination 4a and specifying the actual phone number of the registered number as the caller 4b from the telephone 3 of the registered number, the incoming call response unit 1d extracts the connection destination's phone number and the caller's phone number, and sends them to the user identification unit 1e, if the connection request is sent from the telephone 3 of the registered number. The user identification unit 1e extracts the user identification information and the actual phone number of the user's telephone, based on the user connection number of the connection destination. The phone number search unit 1f extracts a dummy number of the registered number, based on the user identification information and the actual phone number of the caller's registered number. The forwarding processing unit 1g forwards a connection request specifying the user's actual phone number as a forwarding number 4c and specifying the dummy number of the registered number as a caller 4d, to the user's telephone 2, and connects a call between the telephone 3 of the registered number and the user's telephone 2.

In this manner, upon reception of the connection request for telephonic communication with the user from the registered number, the call connector 1 converts the connection destination from the user connection number to the user actual phone number and also the caller from the actual phone number of the registered number to the registered number's dummy number, and forwards the converted information to the user. As a result, it is possible to specify who the caller is before telephonic communication begins, if the registered number's dummy number is set in the telephone directory of the user's telephone 2. At this time, the registered phone number displayed on the user's telephone 2 is a dummy number. Hence, even if a malicious third party uses this dummy number, he/she can not connect to the registered number. Thus, the security of the system can be maintained, like the case wherein the confidentiality of the telephone directory is ensured.

Descriptions will now specifically be made to an example in which this embodiment is applied to a secure telephone directory system for managing the telephone directory of the user using a database to perform a connection service, with reference to the illustration.

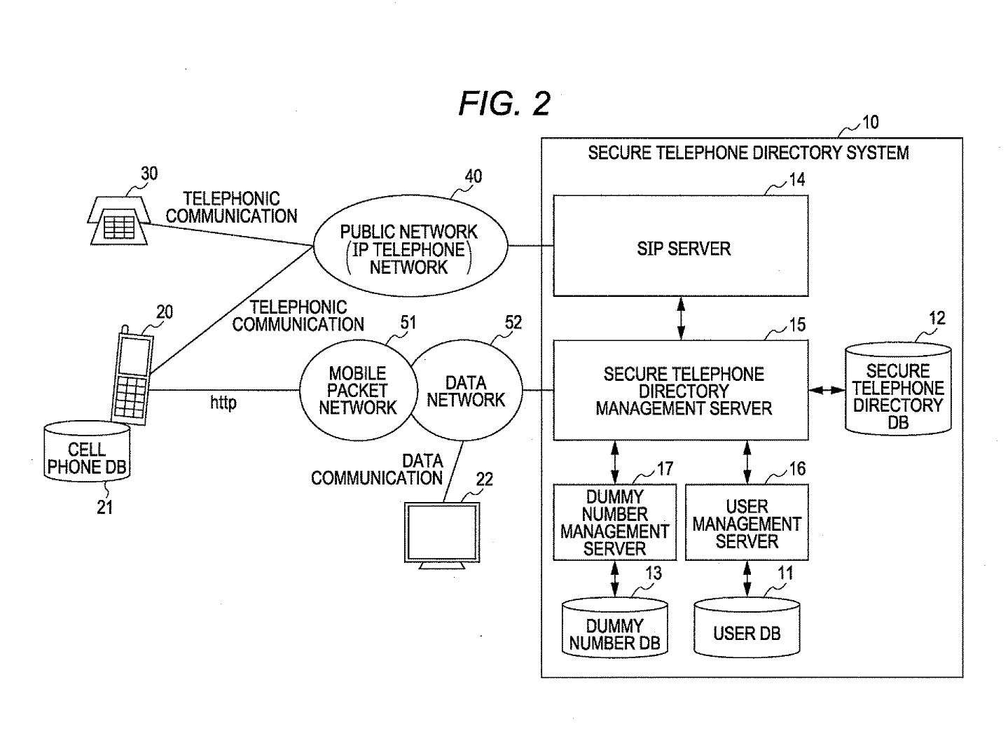

FIG. 2 is a diagram showing a configuration of a secure telephone directory system according to an embodiment. A secure telephone directory system 10 of this embodiment controls call connections between a cell phone 20 of a user and a customer's phone 30 of a customer registered by the user in a secure telephone directory, based on the secure telephone directory registered in advance by the user.

The secure telephone directory system 10 includes a SIP (Session Initiation Protocol) server 14, a secure telephone directory management server 15, a user management server 16 and a dummy number management server 17. The server 14 connects with a public network 40 which includes an IP (Internet Protocol) telephone line. The server 15 manages the secure telephone directory stored in a secure telephone directory DB (Database) 12. The server 16 manages user information stored in a user DB 11. The server 17 manages dummy number information stored in a dummy number DB 13.

The secure telephone directory DB 12 is a database storing the secure telephone directory in which the user registers a customer(s) to make telephonic communication with the user. This DB 12 corresponds to the telephone-directory information storage 1b of FIG. 1. The user DB 11 stores user information regarding a user(s). This DB 11 corresponds to the user information storage 1a of FIG. 1. The dummy number DB 13 stores a dummy number(s) assigned to the customer. This DB 13 corresponds to the dummy number storage 1c of FIG. 1.

The SIP server 14 proceeds voice communications implemented through the public network 40 connected via the non-illustrative gateway.

The secure telephone directory management server 15 connects with the secure telephone directory DB 12, and manages the secure telephone directory stored in the secure telephone directory DB 12. The secure telephone directory management server 15 also collaborates with the SIP server 14, the user management server 16 and the dummy number management server 17 to control call connections using the secure telephone directory. The server 15 performs data communications with the user's cell phone 20 through a data network 52 connected with a mobile packet network 51, reads and updates the secure telephone directory in the secure telephone directory DB 12, and implements a communication process, such as a call connection request using the secure telephone directory. In response to a request from a user PC (Personal Computer) 22, the server 15 connects with the user PC 22 through the data network 52 to read and write information from and to the secure telephone directory in the secure telephone directory DB 12.

The user management server 16 manages user information stored in the user DB 11, searches the user information in response to a request from the secure telephone directory management server 15, and sends back desired data.

The dummy number management server 17 manages the dummy number information stored in the dummy number DB 13, searches dummy number information in response to a request from the secure telephone directory management server 15, and sends back desired data.

The server configuration of FIG. 2 is a combination example of servers of the secure telephone directory system 10, and thus can be formed in any other combination form of the servers depending on an amount of data to be handled.

The user's cell phone 20 sends and receives voice signals to and from the customer's phone 30 through the public network 40 to begin telephonic communications and also perform data communications with the secure telephone directory system 10 through the mobile packet network 51. The data communications between the user's cell phone 20 and the secure telephone directory system 10 can be realized using an HTTP (Hyper Text Transfer Protocol). The cell phone 20 includes a cell phone DB 21 that stores a telephone directory(s), storing a customer(s) registered by the user in the secure telephone directory and a dummy number assigned to the customer in association with each other. The user's cell phone 20 has an actual phone number and a user connection number. The actual phone number corresponds to a generally used phone number that is assigned for connecting to the user's cell phone 20 through the public network 40, while the user connection number is assigned for connecting to the user's cell phone 20 through the secure telephone system 10. When a telephone call is made from the customer's phone 30 to the actual phone number of the cell phone number of the user, this call is directly connected to the cell phone 20 of the user through the public network 40. On the other hand, when a telephone call is made from the customer's phone 30 to the user connection number of the user's cell phone, this call is connected to the secure telephone system 10, thereafter being forwarded to the user's cell phone 20. Data communications can be implemented between the cell phone 20 of the user and the user PC 22 by cell phone cooperative software included in the cell phone 20 of the user and the user PC 22.

The customer's phone 30 is an IP telephone which sends and receives voice data using an IP (Internet Protocol). The customer's phone 30 has an actual phone number for directly connecting to the customer's phone 30 through the public network 40. A dummy number is set for the customer's phone 30 in the secure telephone system 10. The dummy number is information for making the actual phone number of the customer's phone 30 confidential, and thus is not necessary to notify the customer of the information. If one person makes a phone call to the dummy number, this call is connected to the secure telephone system 10. Then, the secure telephone system 10 implements a predetermined process, such as an error process, etc. for the call.

Descriptions will now be made to the processing flow in the above-described security telephone directory system, both in a case where a telephone call is made from the user's cell phone 20 and a case where a telephone call is made from the customer's phone 30.

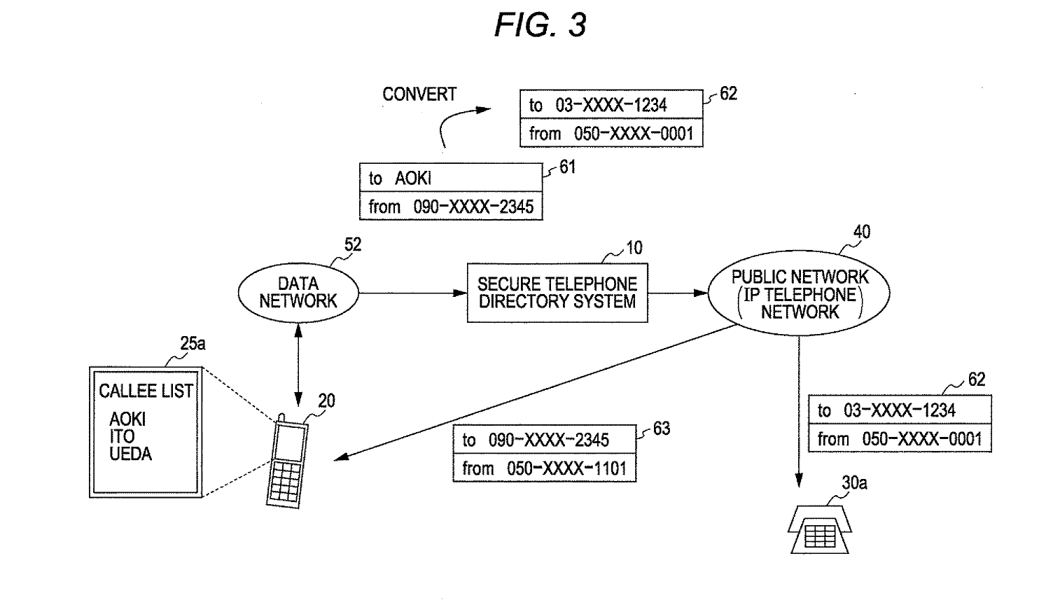

FIG. 3 is a diagram showing a processing flow when a telephone call is made from the user's cell phone 20 to a customer's phone 30a.

The user who possesses the user's cell phone 20 registers in advance information regarding a person(s) to make telephone communication with the user, in the secure telephone directory DB 12 of the secure telephone system 10. The secure telephone directory DB 12 stores telephone directory information of this user in association with a user ID identifying the user.

When the user intends to establish telephonic communication, he/she operates the cell phone 20 of the user to connect the user's cell phone 20 to the secure telephone system 10 through the data network 52. The cell phone 20 of the user sends a user ID specifying the user to the secure telephone directory system 10. Upon reception of the user ID, the secure telephone directory system 10 searches the secure telephone directory DB 12 based on the sent user ID to extract the secure telephone directory information corresponding to this user. The user's cell phone 20 displays a list of telephone numbers for telephonic communication (callee list) that are registered in the secure telephone directory information, on a callee selection display 25a, based on the secure telephone information sent back from the secure telephone system 10. The user operates the callee selection display 25a to select a desired destination number from the list. Upon input of the selected number, the user's cell phone 20 informs the secure telephone directory system 10 of the selected contents through the data network 52. At this time, a connection request 61 specifying the calling number shown with “to” and the caller shown with “from” is sent to the secure telephone directory system 10. The example of FIG. 3 shows the connection request 61 specifying “Aoki” as its destination and specifying “090-XXXX-2345” as an actual phone number of the user's cell phone 20 as the caller.

Upon acquisition of the connection request 61 from the user's cell phone 20, the secure telephone directory system 10 refers the user information stored in the user DB 11, and converts the information specified as the callee into an actual phone number of the callee. That is, the system converts the callee “Aoki” to its actual phone number “03-XXXX-1234”. The system 10 converts information regarding the caller from the actual phone number “090-XXXX-2345” assigned to the user's cell phone 20 to a user connection number “050-XXXX-0001”. The system 10 directs a call to the customer's phone 30a through the public network 40, based on a connection request 62 as a converted result. Simultaneously, the system 10 produces a call 63 whose callee corresponds to the actual phone number “090-XXXX-2345” of the user's cell phone 20 and whose caller corresponds to the actual phone number “050-XXXX-1101,” of the secure telephone system 10, toward the user's cell phone 20 that has originally requested the call, and makes a call to the user's cell phone 20 through the public network 40. When the customer's phone 30a and the user's cell phone 20 respond to the telephone call, the secure telephone directory system 10 begins to intervene between the two telephone connection points to transmit voice data, thereby enabling telephonic communications therebetween.

According to thus configured system, the user can go out without storing information representing telephone numbers of the customers in the cell phone 20. This can prevent leakage of personal information due to loss of the cell phone 20 outside the company or the like.

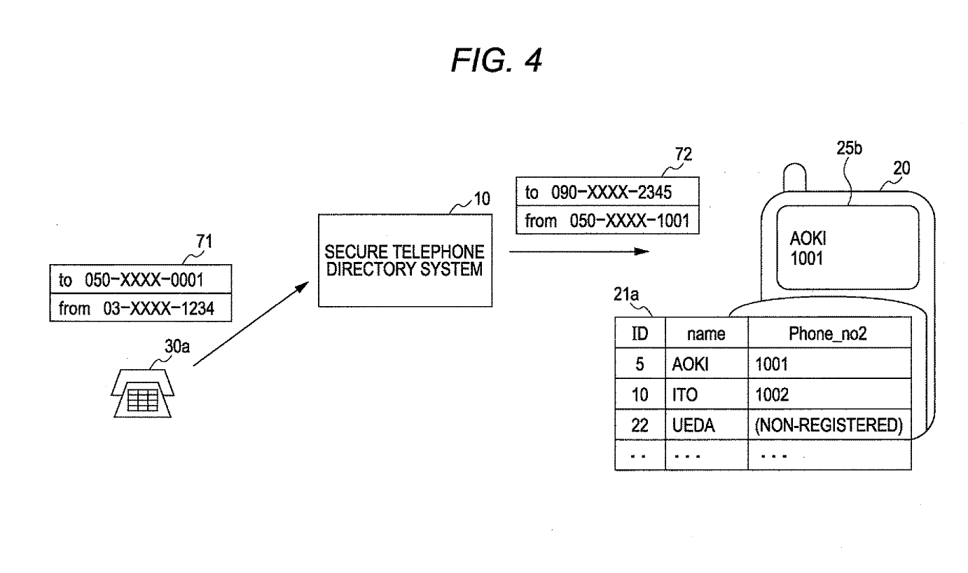

FIG. 4 is a diagram showing a processing flow when a telephone call is made from the customer's phone 30a to the user's cell phone 20.

A cell phone DB 21a of the cell phone 20 stores in advance a cell-phone directory storing a customer name(s) and a dummy number(s) in association with each other.

The customer sends a connection request 71 to the secure telephone directory system 10. The destination of this connection request 71 is the user connection number “050-XXXX-0001” corresponding to the user's cell phone 20 and being acquired with an incoming call from the user's cell phone 20 as shown in FIG. 3. At this time, caller's information included in the connection request 71 is the actual phone number “03-XXXX-1234” of the customer's phone 30a. This connection request 71 is sent to the secure telephone directory system 10.

The secure telephone system 10 refers the user information DB 11, to convert the destination of the sent connection request 71 to the actual phone number “090-XXXX-2345” of the user's cell phone 20 corresponding to the user connection number. The system 10 refers to the secure telephone directory DB 12 or the dummy number DB 13 as needed, to convert the caller to a dummy number “050-XXXX-1001” assigned to the actual phone number of the customer's phone 30a. A connection request 72 as a conversion resultant is sent to the cell phone 20 through the public network 40.

When this connection request 72 is sent to the cell phone 20, the cell phone verifies the phone number (dummy number: 050-XXXX-1001) of the caller of the connection request 72 with registered information (Phone_no2) of the cell phone directory 21a stored in the cell phone DB 21, and extracts a corresponding name “AOKI”. Then, the cell phone displays the extracted name “AOKI” as the caller's name on an incoming call display 25b.

According to thus configured system, the user's cell phone 20 can specify the caller of the call connection which is sent through the secure telephone system 10. Since the telephone number(s) registered in the telephone directory maintained by the cell phone 20 is a dummy number, even if the user loses the cell phone, there is no risk of leakage of the personal information.

Descriptions will now be made to a hardware configuration of the secure telephone directory management server 15.

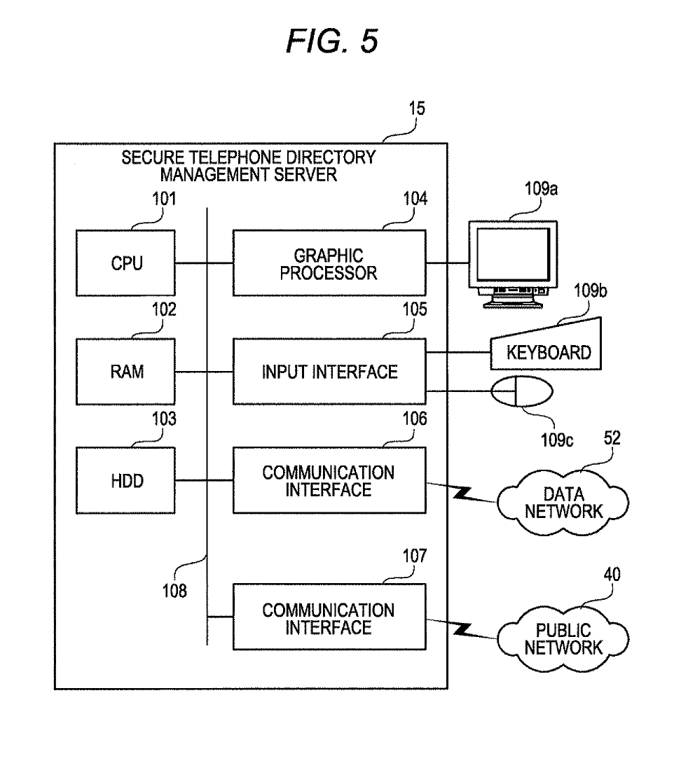

FIG. 5 is a diagram showing a hardware configuration of a secure telephone directory management server. The secure telephone directory management server 15 is controlled by a CPU (Central Processing Unit) 101 in its entirety. The CPU 101 is connected with a RAM (Random Access Memory) 102, a hard disk drive (HDD) 103, a graphic processor 104, an input interface 105 and communication interfaces 106 and 107, through a bus 108.

The RAM 102 temporarily stores at least a part of an OS (Operating System) program or application programs executed by the CPU 101. The RAM 102 stores various data necessary for the processing implemented by the CPU 101. The HDD 103 stores the OS program or application program, etc.

The graphic processor 104 is connected with a monitor 109a. The graphic processor 104 controls the monitor 109a to display an image on its display in accordance with instructions from the CPU 101. The input interface 105 is connected with a keyboard 109b and a mouse 109c. The input interface 105 sends signals sent from the keyboard 109b and the mouse 109c, to the CPU 101 through the bus 108. The communication interface 106 is connected with the data network 52. The communication interface 107 is connected with the public network 40.

According to the above hardware configuration, processing functions of the present invention can be realized. FIG. 5 shows the configuration of the secure telephone directory management server 15. However, the same configuration is applied to the SIP server 14, the user management server 16 and the dummy number management server 17.

Descriptions will now be made to a configuration of program modules of this embodiment.

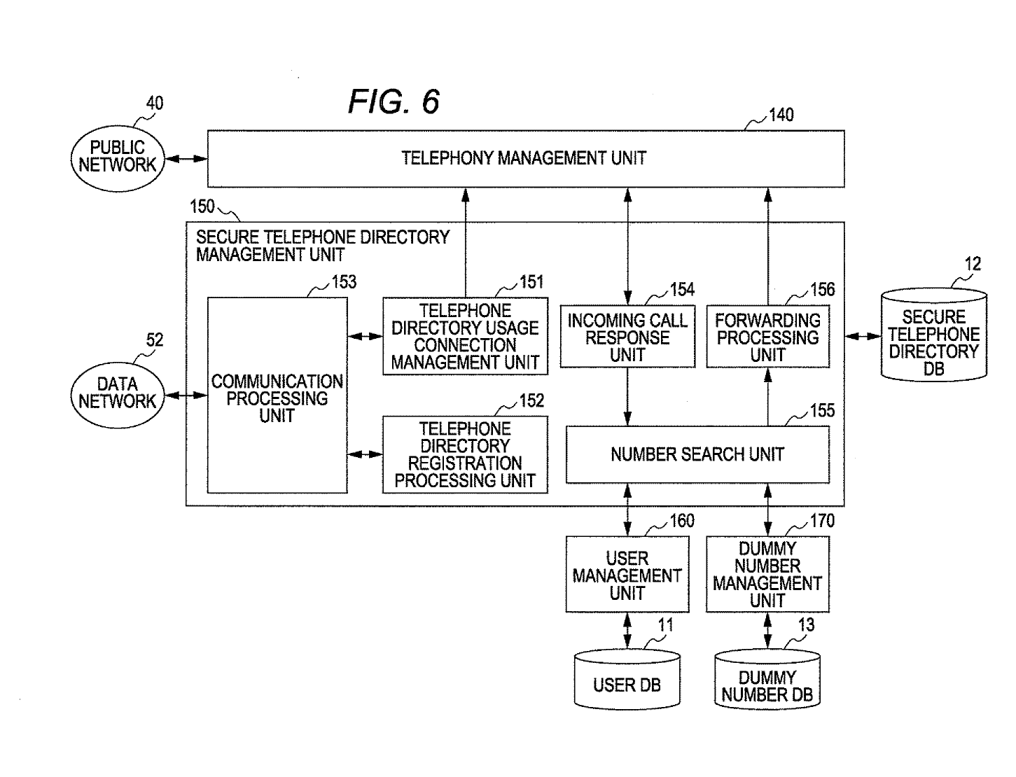

FIG. 6 is a block diagram showing functions of a secure telephone directory system. The same components as those shown in FIG. 2 are identified by the same reference numerals, and thus will not be explained here.

The secure telephone system 10 includes a telephony management unit 140, a secure telephone directory management unit 150, a user management unit 160 and a dummy number management unit 170.

The telephony management unit 140 is connected with the public network 40, and controls an incoming call voice signal input from the public network 40 and a calling signal output to the public network 40.

The secure telephone directory management unit 150 is connected with the secure telephone directory DB 12. The secure telephone directory management unit 150 includes a telephone directory usage connection management unit 151, a telephone directory registration processing unit 152, a communication processing unit 153, an incoming call response unit 154, a number search unit 155 and a forwarding processing unit 156. The telephone directory usage connection management unit 151 is connected with the data network 52 through the communication processing unit 153, checks a user ID in response to a request for the secure telephone directory from the user's cell phone 20, and sends the secure telephone directory data of the corresponding person. When the user's cell phone 20 has input a connection request upon selection of the calling number, the unit 150 converts between the caller and callee of the connection request, as shown in FIG. 3, and requests the telephony management unit 140 to call and begin telephonic communication.

The telephone directory registration processing unit 152 is connected with the data network 52 through the communication processing unit 153, and performs processes for registering and editing a telephone directory information of a user which is stored in the secure telephone directory DB 12, in response to a request from the user PC 22 or user's cell phone 20. The communication processing unit 153 is connected with the data network 52, and controls data communications between the user's cell phone 20 or user PC 22 and the telephone directory usage connection management unit 151 and the telephone directory registration processing unit 152. The incoming call response unit 154 instructs the telephone management unit 140 to transmit forwarding guidance representing that it is in a forwarding process, when the telephony management unit 140 receives a connection request. In addition, the unit 154 informs the number search unit 155 about the set numbers of the caller and callee of the connection request received by the number search unit 155.

The number search unit 155 instructs the user management unit 160 and the dummy number management unit 170 to search for numbers to convert between the callee and caller of the connection request received by the number search unit. The unit 155 searches the secure telephone directory DB 12 for dummy number specification information of the registered number. The acquired number is sent to the forwarding processing unit 156. The forwarding processing unit 156 converts the connection request using the number searched by the number search unit 155, and requests the telephony management unit 140 to send the information to the callee.

The user management unit 160 searches the user DB 11 in accordance with an instruction of the number search unit 155 to extract a user ID set in the user information, the actual phone number of the user's cell phone and the user connection number of the user's cell phone.

The dummy number management unit 170 searches and extracts a dummy number corresponding to a dummy number ID for identifying the dummy number, in accordance with an instruction of the number search number unit 155.

Descriptions will now be made to information stored in each of the DBs.

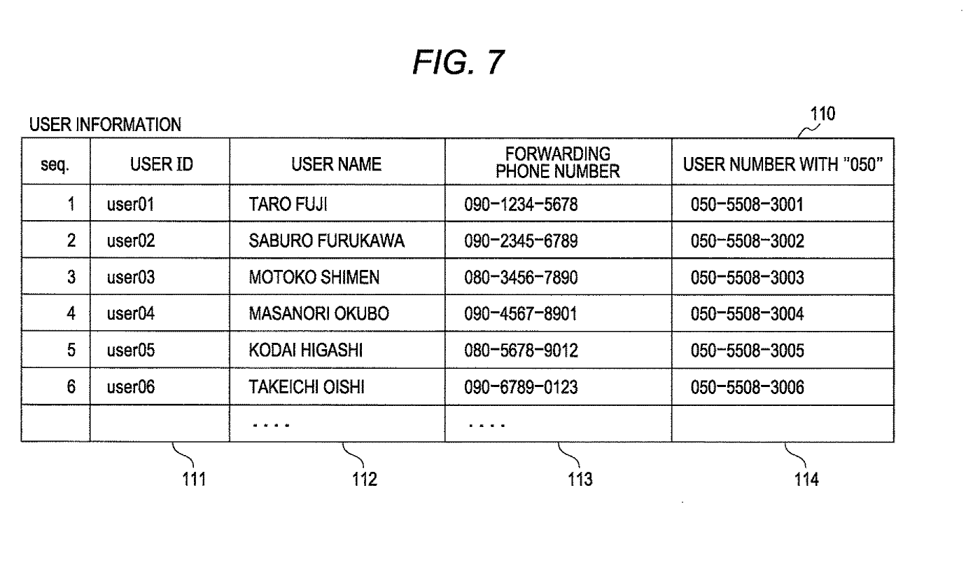

FIG. 7 is a diagram showing an example of user information stored in the user DB 11 of the secure telephone directory system 10.

User information 110 includes user names 112, forwarding phone numbers 113 and user numbers with “050” 114, in association with user IDs 111 for identifying users. The user ID 111 is user identification information specifying the individual user. The user name 112 includes a set user name. The forwarding phone number 113 is an actual phone number of a telephone, such as the user's cell phone 20 specified by the user as a forwarding destination. The user number with “050” 114 is a user connection number, and includes a phone number for calling the secure telephone system 10. For example, as to data of a sequence number 1, the user name of a user specified by user ID “user01” is “TARO FUJI”. In this case, a phone call is forwarded to the user, while the forwarding phone number of “090-1234-5678” is set as the callee. For the call from the user, data representing the user number with “050” of “050-5508-3001” as the caller is registered.

Assume that a phone number that begins with “050” is assigned to the secure telephone directory system 10. In the descriptions below, the user connection number is the user number with “050”.

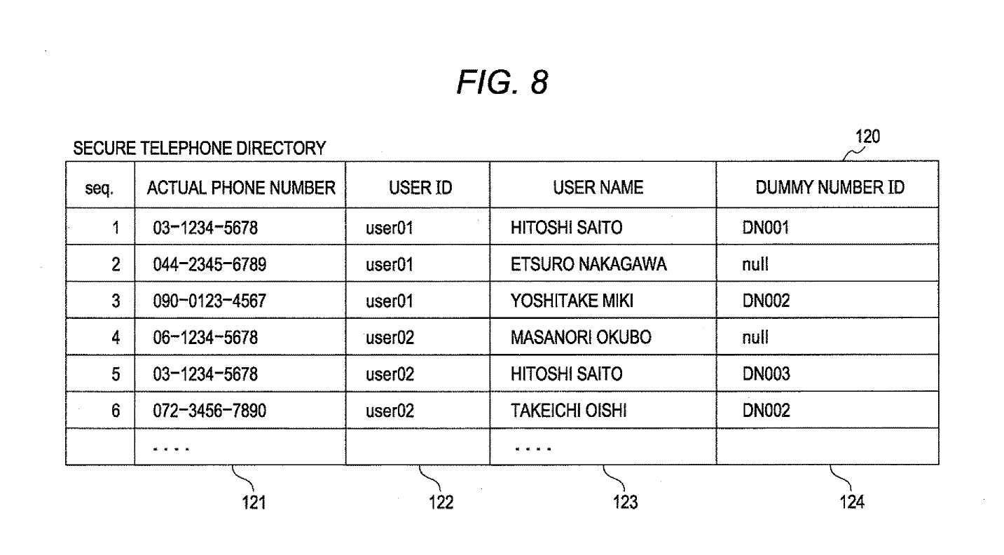

FIG. 8 is a diagram showing an example of the secure telephone directory stored in the secure telephone directory DB 12 of the secure telephone system 10.

The secure telephone directory 120 stores actual phone numbers 121 of customers registered as persons to make telephonic communication with the user, user IDs 122 of users, user (customer) names 123 and dummy number IDs 124, in association with each other. The actual phone numbers 121 include the actual phone numbers of customers who are registered by users identified by the user IDs 122. The user (customer) names 123 include names of customers corresponding to the actual phone numbers 121, while the dummy number IDs 124 include information specifying assigned dummy numbers. When no data is registered, “null” is set.

For example, as to data of sequence number 1, a customer whose actual phone number is “03-1234-5678” is registered by a user identified by a user ID “user01”, and the customer name is “HITOSHI SAITO”. In addition, the directory 120 includes data assigned in order to specify the customer with “DN001”, as a dummy number. As illustrated in FIG. 8, a dummy number ID may include a combination of one or more letters and numbers, or any type of indicator assigned to a customer. Note that different dummy number IDs are given to the respective customers, for each user of the same user ID. However, the same dummy number IDs may be given to different user IDs. For example, in the records of sequence number 3 and sequence number 6, the same dummy number IDs may be set, since the records contain different data regarding their user IDs.

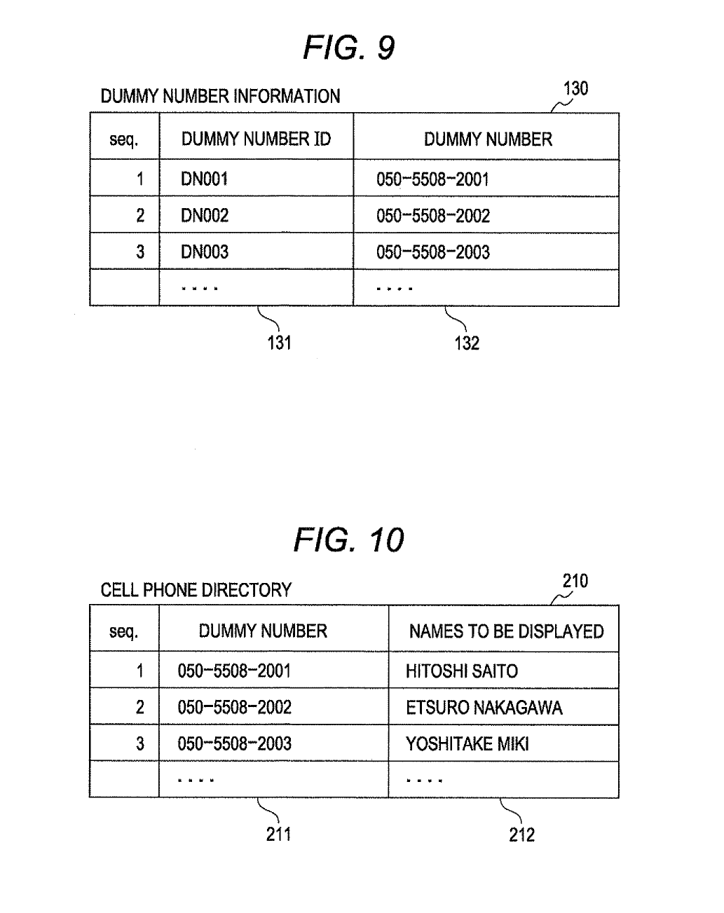

FIG. 9 is a diagram showing an example of dummy number information stored in the dummy number DB 13 of the secure telephone directory system 10.

Dummy number information 130 includes dummy number IDs 131 and dummy numbers 132 in association with each other. The dummy number IDs 131 include data corresponding to the data registered in the dummy number ID 124 of the secure telephone directory 120. For example, the registered number is a dummy number “050-5508-2001” corresponding to the dummy number ID “DN001” assigned to the customer registered in the record of sequence number 1 of the secure telephone directory 120.

FIG. 10 is a diagram showing an example of the cell phone directory stored in the cell phone DB 21 of the user's cell phone 20.

A cell phone directory 210 stores dummy numbers 211 and names to be displayed 212 in association with each other. The dummy numbers 211 are set numbers corresponding to the dummy number IDs set for the dummy number IDs 124 of the secure telephone directory 120. The names to be displayed 212 are set names to be displayed on the display of the cell phone 20, when the dummy number 211 is received. Normally, the names 212 are the customer names 123 of the secure telephone directory 120, however, names that are arbitrarily chosen by the user may be set. For example, when this user is one having the user ID “user01”, information to be set in the cell phone directory 210 include both of the customer name “HITOSHI SAITO” registered by this user and the dummy number “050-5508-2001” specified by a corresponding dummy number ID “DN001”, based on the secure telephone directory 120. The method for setting such information will specifically be described below.

Descriptions will now be made to the flow of a call connection process in the above-described secure system.

As described above, when the user makes a call using the secure telephone directory system 10, the customer's phone 30 as the callee receives the call representing a user number with “050” as the caller. When the customer makes a call to the user, he/she uses this user number with “050” as the callee. The user may inform the customer of the user number with “050” in advance.

This connection request, specifying the user number with “050” sent by the customer's phone 30 as the callee, is received by the secure telephone system 10. Descriptions will now be made to a processing flow after the incoming call of the user number with “050” is detected, in thus configured secure telephone system 10. In the descriptions below, the processing orders are provided.

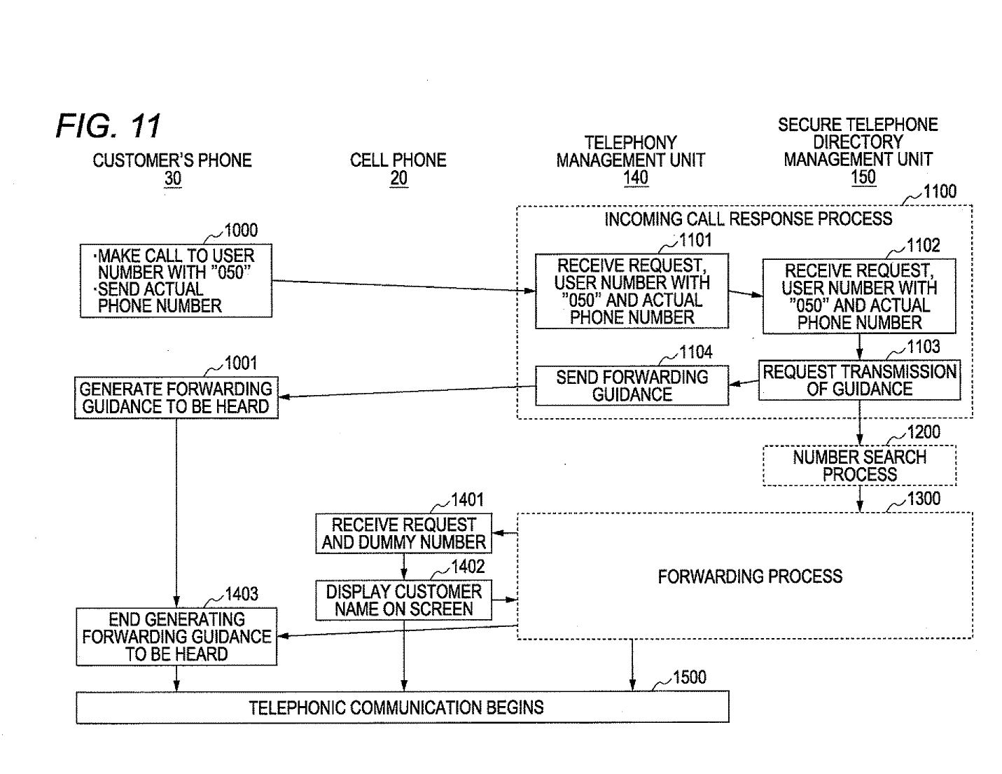

FIG. 11 to FIG. 13 show a processing flow from when a call made by the customer registered in the secure telephone directory 120 is received by the secure telephone directory system, until when the call is connected with the user's cell phone 20. Note that the connection request destination is the user number with “050”.

FIG. 11 is a workflow diagram showing procedure(s) in relation to when the secure telephone system 10 receives a connection request specifying a user number with “050” as the connection destination until when telephonic communication begins.

At process 1000, the customer's phone 30 sends a connection request specifying the user number with “050” as the callee and specifying the actual phone number of the customer's phone 30 as the caller.

This connection request is received by the secure telephone system 10. Then, the system implements an incoming call response process 1100 including the procedures below.

At process 1101, the telephony management unit 140 receives the connection request (callee=user number with “050”, caller=customer actual phone number), and sends the request to the secure telephone directory management unit 150.

At process 1102, the secure telephone directory management unit 150 receives the connection request (callee=user number with “050”, caller=customer actual phone number).

At process 1103, the secure telephone directory management unit 150 outputs a guidance transmission request to the telephony management unit 140, and transfers the connection request to a number search process 1200.

At process 1104, the telephony management unit 140 sends forwarding guidance in response to the request from the secure telephone directory management unit 150, to the customer's phone 30. The forwarding guidance is information for informing the customer that it is in a forwarding process. For example, the forwarding guidance is a voice message, such as “Now forwarding, so please wait for a moment”.

Upon completion of the incoming call response process 1100 by the secure telephone directory system 10, a response is sent to the customer's phone 30.

At process 1001, the customer's phone 30 receives the forwarding guidance as a response, and generates the voice message to be heard.

During this time, in the secure telephone directory system 10, the number search process 1200 is activated by the secure telephone directory management unit 150 and implements a number search process for converting the user identification or telephone number, based on phone numbers of the callee and caller. This process is more specifically described below. Once the number is searched, a forwarding process 1300 is activated. The forwarding process 1300 includes a process for converting the numbers of the caller and callee of the connection request, and for making a call to the callee. This process will more specifically be described below. In this forwarding process 1300, the callee corresponds to the actual phone number of the cell phone 20, while the caller corresponds to the dummy number of the customer's phone 30. In this manner, the converted connection request (callee=user actual phone number, caller=customer dummy number) is directed and sent to the cell phone 20 of the callee.

At process 1401, upon reception of the connection request (callee=user actual phone number, caller=customer dummy number), the cell phone 20 receives the dummy number of the customer's phone 30 as the caller.

[At process 1402, the cell phone 20 verifies the received dummy number with the cell phone directory 210 stored in the cell phone directory DB 21 and extracts the customer name to be displayed, and displays the extracted customer name on the display.

At process 1403, the guidance is no longer sent to the customer's phone 30, and also the forwarding guidance to the customer's phone 30 is no longer heard.

At process 1500, the secure telephone directory system 10 connects a call between the customer's phone 30 as the caller and the user's cell phone 20 as the callee, thereby the telephonic communication begins therebetween.

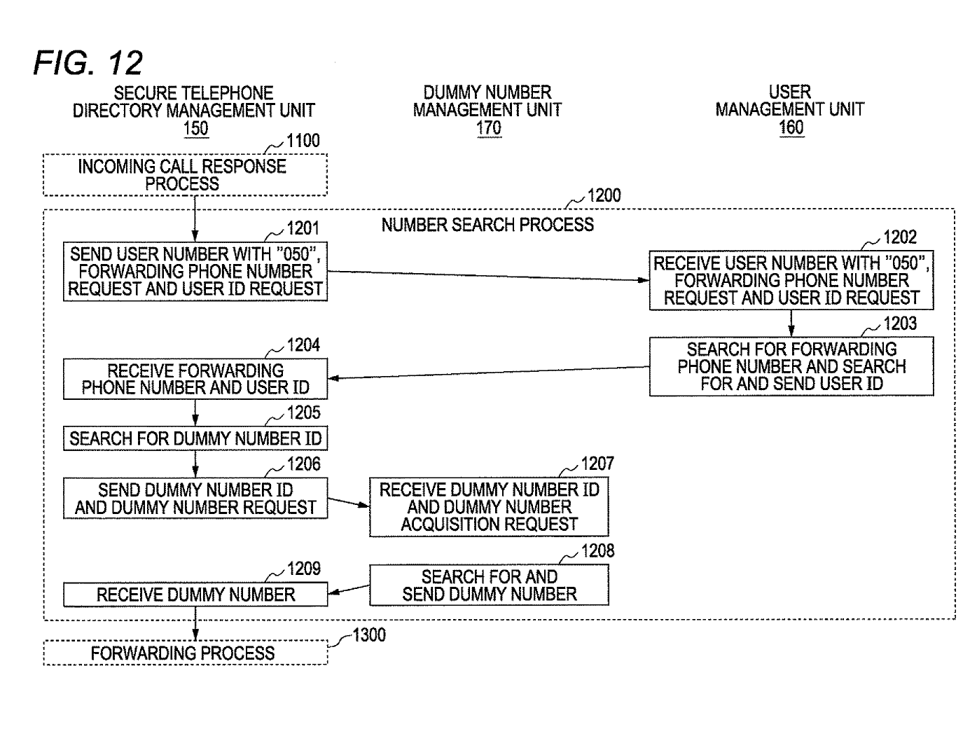

Descriptions will now be made to the number search process 1200. FIG. 12 is a workflow diagram specifically showing the number search process of FIG. 11.

When the incoming call response process 1100 issues a connection request (callee=user number with “050”, caller=customer actual phone number), a number search process begins.

At process 1201, the secure telephone directory management unit 150 sends a forwarding phone number request and a user ID request together with a user number with “050” of the callee to the user management unit 160.

At process 1202, the user management unit 160 receives the user number with “050”, the forwarding phone number request and the user ID request, and begins the process.

At process 1203, the user management unit 160 searches the user DB 11 based on the user number with “050” and extracts a forwarding phone number and user ID corresponding to the user number with “050”. For example, if the unit 160 receives “050-5508-3001” as the user number with “050”, it searches the user information 110 shown in FIG. 7 to acquire the user ID “user01” corresponding to the received user number with “050” and also the forwarding phone number “090-1234-5678”. Then, the unit 160 sends the acquired forwarding phone number and the user ID to the secure telephone directory management unit 150.

At process 1204, the secure telephone directory management unit 150 receives the forwarding phone number and the user ID.

At process 1205, the secure telephone directory management unit 150 searches the secure telephone directory DB 12 based on the user ID and the customer's actual phone number of the caller, to extract a dummy number ID corresponding to the customer's actual phone number. For example, if the received customer's actual phone number is “03-1234-5678” and the user ID is “user01”, the unit 150 searches the secure telephone directory 120 shown in FIG. 8 to acquire the dummy number ID “DN001” corresponding to the same user ID and the same actual phone number.

At process 1206, the secure telephone directory management unit 150 sends the dummy number ID acquired in a process 1204 and a dummy number request to the dummy number management unit 170.

At process 1207, the dummy number management unit 170 receives the dummy number ID and the dummy number acquisition request from the secure telephone directory management unit 150.

At process 1208, the dummy number management unit 170 searches the dummy number DB 13 based on the dummy number ID to extract a dummy number corresponding to the dummy number ID. For example, if the dummy number ID is “DN001”, the unit searches the dummy number information 130 shown in FIG. 9 to acquire the corresponding dummy number “050-5508-2001”. The unit then sends the acquired dummy number to the secure telephone directory management unit 150.

At process 1209, the secure telephone directory management unit 150 receives the dummy number. The unit 150 activates a forwarding process 1300, and sends the forwarding phone number acquired from the user management unit 160 (user's actual phone number) and the dummy number acquired from the dummy number management unit 170 (dummy number of the customer as a caller).

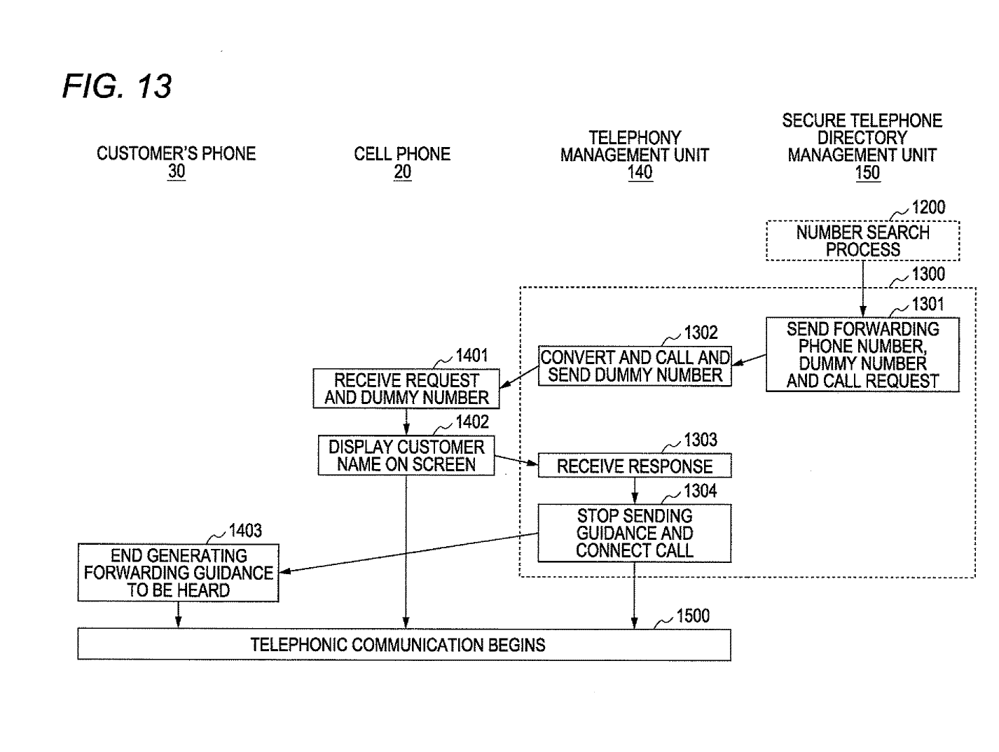

FIG. 13 is a workflow diagram specifically showing the forwarding process of FIG. 11.

When the secure telephone directory management unit 150 issues a forwarding phone number and a dummy number, the forwarding process begins.

At process 1301, the secure telephone directory management unit 150 sends the forwarding phone number acquired in the number search process 1200 (user's actual phone number) and the dummy number (dummy number of the customer as a caller) to the telephony management unit 140, together with a call request.

At process 1302, the telephony management unit 140 converts the phone number of the connection request based on the received forwarding phone number and dummy number, and sends a connection request specifying the forwarding phone number (actual phone number of the user's cell phone 20) as the callee and specifying the dummy number (dummy number of the customer's phone 30) as the caller to the cell phone 20.

At process 1401, the cell phone 20 receives the connection request specifying the dummy number as the caller.

At process 1402, the cell phone 20 searches the cell phone DB 21 based on the dummy number acquired in the process 1401 to extract a to-be-displayed customer name corresponding to the dummy number. For example, if the dummy number is “DN001”, the cell phone 20 searches the cell phone directory 210 shown in FIG. 10 to acquire the customer name “HITOSHI SAITO” corresponding to the same dummy number. The cell phone 20 then displays the acquired customer name on the display, and sends a response to the secure telephone system 10.

At process 1303, the telephony management unit 140 receives the response from the cell phone 20.

At process 1304, the telephony management unit 140 stops sending the forwarding guidance to the customer's phone 30 as the caller, and connects a call between the cell phone 20 and the customer's phone 30.

At process 1403, since the forwarding guidance is no longer sent, the customer's phone 30 ends generating the forwarding guidance to be heard.

At process 1500, the call is connected between the customer's phone 30 and the cell phone 20, thereby telephonic communication begins therebetween.

As a result of the above processes thus implemented, the customer's phone 30 is enabled to make a call to a destination number without having knowledge of its actual phone number, while the user's cell phone 20 can specify the caller without having knowledge of actual phone number.

The dummy number of the customer's phone is not necessarily set for each customer's phone. Descriptions will now be made to a call connection process when a customer's dummy number is not set in the secure telephone directory.

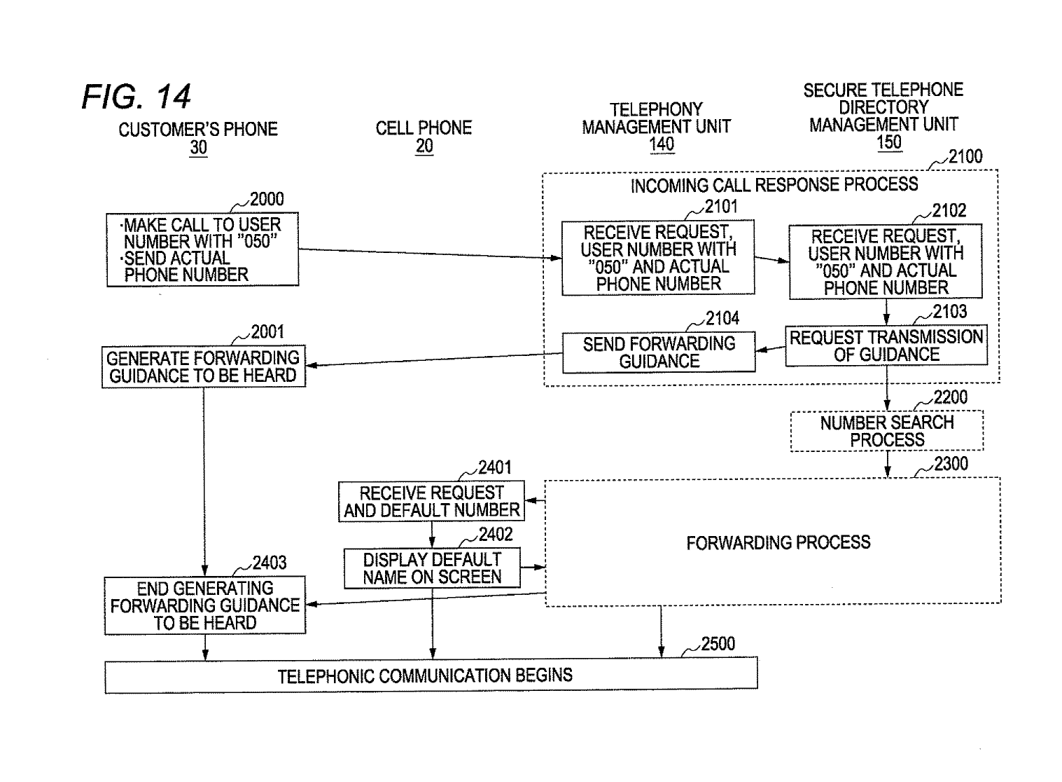

FIG. 14 to FIG. 16 show a processing flow from when a telephone call whose destination is a user number with “050”, until when the call is connected to the user's cell phone.

FIG. 14 is a workflow diagram when a caller's dummy number is not registered in the secure telephone directory in FIG. 11.

Descriptions of processes from process 2000 to 2001 will not be given herein, since these processes are the same as the processes from 1000 to 1001 of FIG. 11. Further, since the incoming call response process 2100 including processes 2101-2104 are similarly implemented as the incoming call response process 1100 including processes 1101-1104 in FIG. 11, descriptions thereof are not repeated.

As is more specifically described below, in a number search process 2200 of the secure telephone directory system 10, a default number is set as a number of the caller, when the customer's dummy number is not registered. The forwarding number is acquired in the same manner as that shown in FIG. 11. In a forwarding process 2300, a connection request is sent to the cell phone 20, based on the forwarding phone number acquired in the number search process 2200 and the dummy number of the default number.

The user's cell phone 20 receives a connection request specifying a default number as the caller, and begins the process.

At process 2401, the cell phone 20 receives the connection request specifying the default number as the caller.

At process 2402, the cell phone 20 displays a default name corresponding to the default number.

The secure telephone directory system 10 stops sending the forwarding guidance, upon acquisition of a response from the cell phone 20.

At process 2403, the customer's phone 30 stops generating the forwarding guidance to be heard.

At process 2500, the secure telephone directory system 10 connects a call between the customer's phone 30 as the caller and the user's cell phone 20 as the callee, thereby telephonic communication begins therebetween.

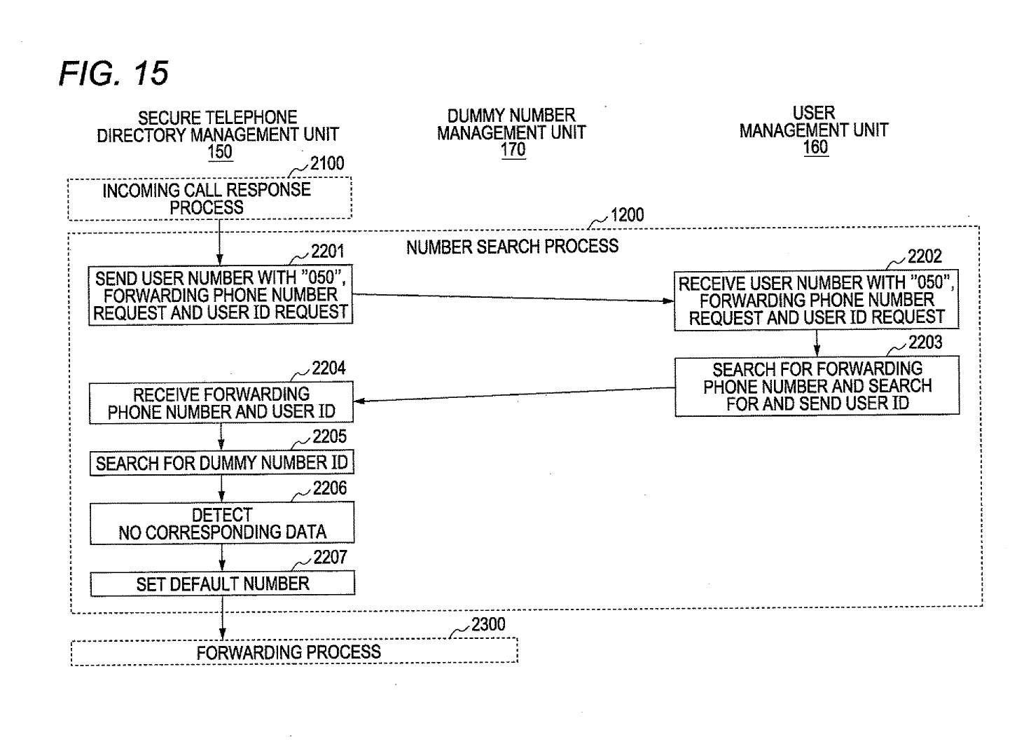

FIG. 15 is a workflow diagram specifically showing the number search process of FIG. 14.

Since the customer's dummy number is not registered, a number search process differs from that of FIG. 12. When a connection request (callee=user number with “050”, caller=customer's actual phone number) is issued in an incoming call response process 2100, a number search process begins.

At process 2201, the secure telephone directory management unit 150 sends a forwarding phone number request and a user ID request together with a user number with “050” of the callee to the user management unit 160.

At process 2202, the user management unit 160 receives the user number with “050”, the forwarding phone number request and the user ID request, and begins the process.

At process 2203, the user management unit 160 searches the user DB 11 based on the user number with “050” to extract the forwarding phone number and user ID corresponding to the user number with “050”, and sends the extracted information to the secure telephone directory management unit 150.

At process 2204, the secure telephone directory management unit 150 receives the forwarding phone number and the user ID.

At process 2205, the secure telephone directory management unit 150 searches the secure telephone directory DB 12 for a dummy number ID, based on the user ID and the customer actual phone number of the caller.

At process 2206, in the secure telephone directory DB 12, a dummy number of this customer is not registered in the secure telephone directory of a corresponding user. Though the secure telephone directory management unit 150 searches for the number, no corresponding is detected.

At process 2207, the secure telephone directory management unit 150 sets a default number instead of a dummy number. The default number is set in advance for each customer without a dummy number, thus having no corresponding relationship between the individual customer and the default number. The forwarding process 2300 is activated to send a forwarding phone number (user's actual phone number) acquired from the user management unit 160 and the default number.

In this manner, when no dummy number ID is detected, the dummy number management unit 170 sets a default number as a dummy number.

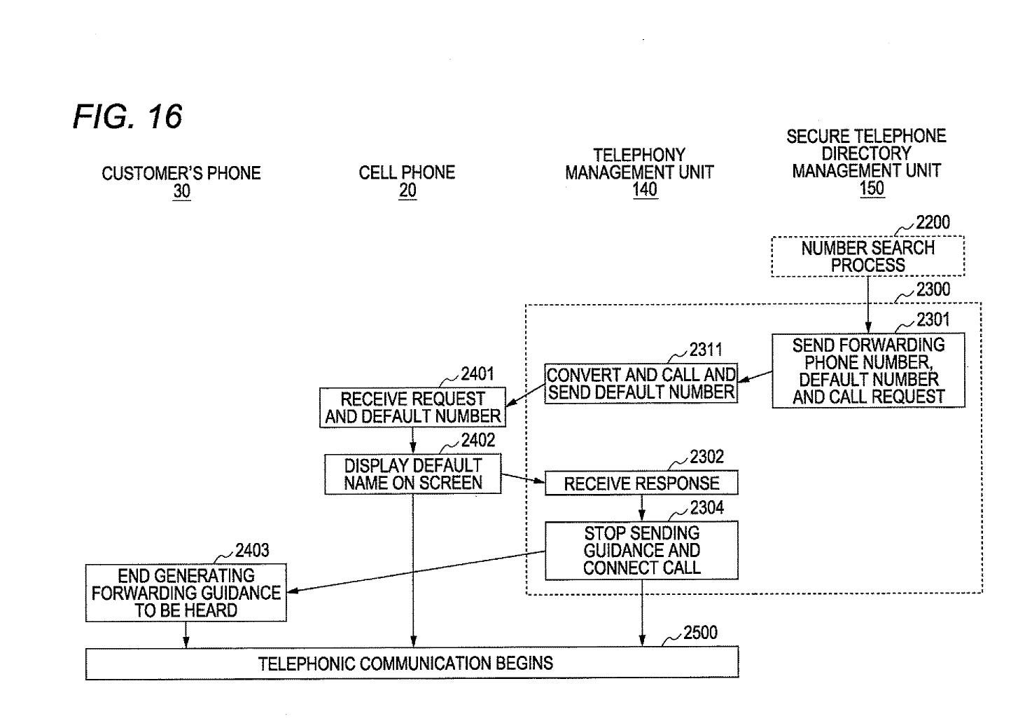

FIG. 16 is a workflow diagram specifically showing the forwarding process 2300 of FIG. 14.

The process begins, upon reception of the forwarding phone number and default number from the secure telephone directory management unit 150.

At process 2301 the secure telephone directory 150 sends the forwarding phone number (user's actual phone number) acquired in the number search process 1200 and the default number to the telephony management unit 140, together with a call request.

At process 2311, the telephony management unit 140 converts the phone number of the connection request based on the received forwarding phone number and the default dummy number, and sends a connection request specifying the forwarding number as the callee (actual phone number of the user's cell phone 20) and specifying the default dummy number as the caller, to the cell phone 20.

Descriptions will now be made to a process of the cell phone 20 which has received the connection request.

At process 2401, the cell phone 20 receives the connection request specifying the default dummy number as the caller.

At process 2402, the cell phone 20 searches the cell phone DB 21 based on the default dummy number acquired in the process 2401 to extract a to-be-displayed customer name corresponding to the default dummy number. If the to-be-displayed customer name is set for the default dummy number, the name is displayed. If not, no name is displayed. Then, the cell phone sends a response back to the secure telephone directory system 10.

Descriptions will now be made to the process of secure telephone directory system 10 which has received the response.

At process 2302, the telephony management unit 140 receives a response from the cell phone 20.

At process 2304, the telephony management unit 140 stops sending the forwarding guidance sent to the customer's phone 30 as the caller, and connects a call between the cell phone 20 and the customer's phone 30.

At process 2403, since the forwarding guidance is no longer sent, the customer's phone 30 stops generating the forwarding guidance to be heard.

At process 2500, the call is connected between the customer's phone 30 and the cell phone 20, thereby telephonic communication begin therebetween.

Upon implementation of the above process(es), the default dummy number is sent to the user's cell phone 20, thus preventing leakage (including unauthorized use) of the caller's actual phone number, though the caller can not be specified at the cell phone 20.

Note that the actual phone number of the customer's phone 30 will not be sent from the customer's phone 30 to the secure telephone directory system 10, when anonymous setting is done for the customer's phone 30. A call connection process of this case will be described later.

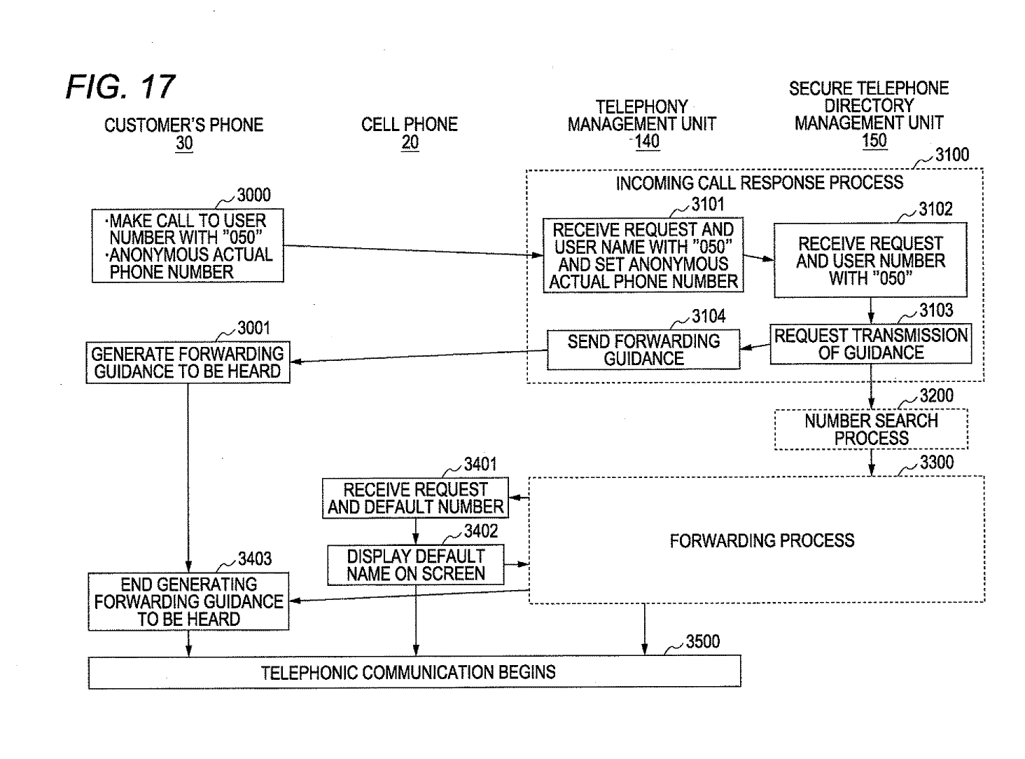

FIG. 17 is a workflow diagram when an actual phone number of the caller is “unknown”.

At process 3000, the customer's phone 30 sends a connection request specifying the user number with “050” as the callee and specifying an anonymous caller.

The secure telephone directory system 10 receives this connection request, and begins the process.

At process 3101, the telephony management unit 140 receives request sends the connection request (callee=user number with “050” unknown caller) to the secure telephone directory management unit 150.

At process 3102, the secure telephone directory management unit 150 receives the connection request.

At process 3103, the secure telephone directory management unit 150 requests for transmission of guidance, and activates a number search process 3200.

At process 3104, the telephony management unit 140 sends forwarding guidance.

The forwarding guidance is sent to the customer's phone 30.

At process 3001, the customer's phone 30 generates a guidance to be heard.

As will specifically be described below, in the number search process 3200 of the secure telephone directory system 10, the customer may not be specified. Thus, a default dummy number is set instead of the dummy number for the caller. A forwarding number is acquired in the same manner as that shown in FIG. 11. In a forwarding process 3300, a connection request is sent to the cell phone 20, based on the forwarding phone number acquired in the number search process 2200 and the default dummy number. This forwarding process is the same as that performed when the customer dummy number of the caller is not registered (as shown in FIG. 16), and thus will not be explained here.

The user's cell phone 20 receives a connection request specifying a default dummy number as the caller, and begins the process.

At process 3401, the cell phone 20 receives the connection request specifying the default dummy number as the caller.

At process 3402, the cell phone 20 displays a default name corresponding to the default dummy number on its display.

The secure telephone directory system 10 stops sending the forwarding guidance, upon acquisition of the response from the cell phone 20.

At process 3403, the customer's phone 30 stops generating the forwarding guidance to be heard.

At process 3500, the secure telephone directory system 10 connects a call between the customer's phone 30 as the caller and the user's cell phone 20 as the callee, thereby telephonic communication begins therebetween.

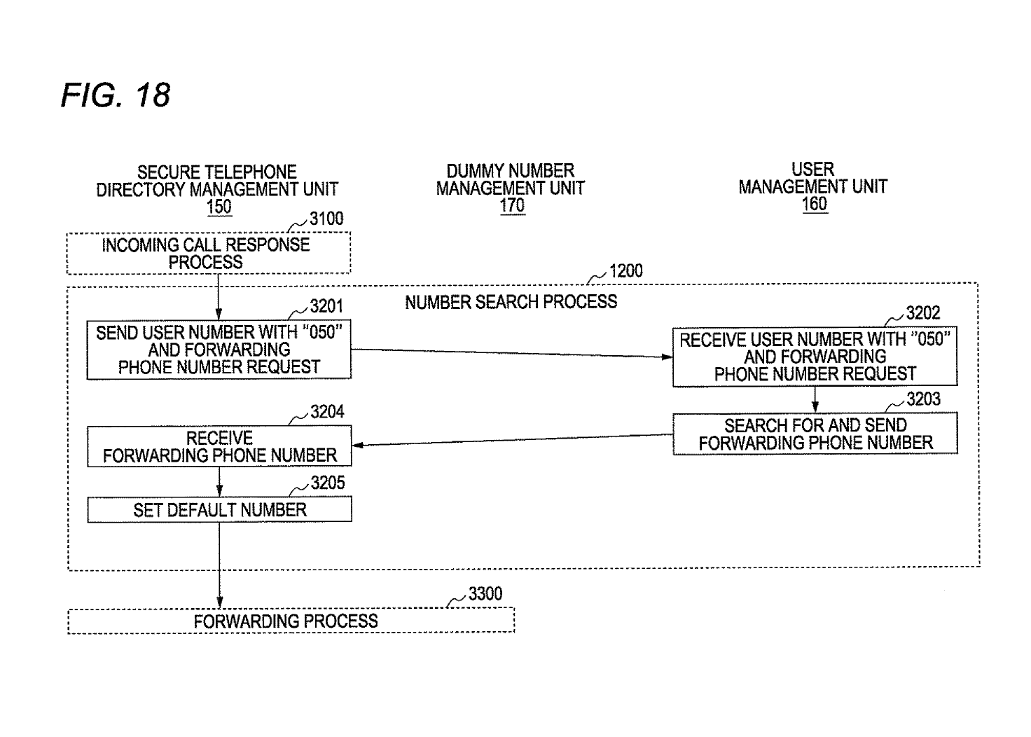

FIG. 18 is a workflow diagram specifically showing the number search process of FIG. 17.

Because the actual phone number of the caller is unknown, the number search process differs from that of FIG. 12 and FIG. 15. Upon reception of a connection request (callee=user number with “050”, unknown caller) from an incoming call response process 3100, the process begins.

At process 3201, the secure telephone directory management unit 150 sends a forwarding phone number request together with the user number with “050” of the caller to the user management unit 160. Because the caller cannot be specified, it is not necessary to request the user ID like the case of the process 1201 of FIG. 12.

At process 3202, when the user management unit 160 receives the user number with “050” and the forwarding phone number request, it begins the process.

At process 3203, the user management unit 160 searches the user DB 11 based on the user number with “050” to extract a forwarding phone number corresponding to the user number with “050”, and sends the extracted number to the secure telephone directory management unit 150.

At process 3204, the secure telephone directory management unit 150 receives the forwarding phone number.

At process 3205, the secure telephone directory management unit 150 sets a default dummy number instead of a dummy number, and activates the forwarding process 3300. At this time, the unit 150 sends the forwarding phone number (user's actual phone number) acquired from the user management unit 160 and the dummy number (default number).

In this manner, when the caller is unknown, the default dummy number is set, without requiring the search process for the user ID by the user management unit 160 and without the process by the dummy number management unit 170 being implemented.

As a result that the above processes are thus implemented, even if the caller is unknown, the connection destination is converted to the actual phone number of the user's cell phone to be forwarded to the user's cell phone 20, when the call connection request specifying the user number with “050” as the connection destination is received by the secure telephone directory system 10.

Descriptions will now be made to a process performed when the cell phone 20 sends a connection request specifying, as a callee, a customer's dummy number stored in the cell phone directory, to the secure telephone directory system 10.

The system should invalidate such a connection request that specifies a caller with a dummy number as a callee. However, it can be imagined that the user directly makes a call to a person in the callee list from the telephone directory of the cell phone. Therefore, this process is to control a call connection to the callee person, in such a case. Of course, the system may treat the connection request, specifying the dummy number as the callee, as an error, or implement a process for sending guidance requesting to make a call from the callee list.

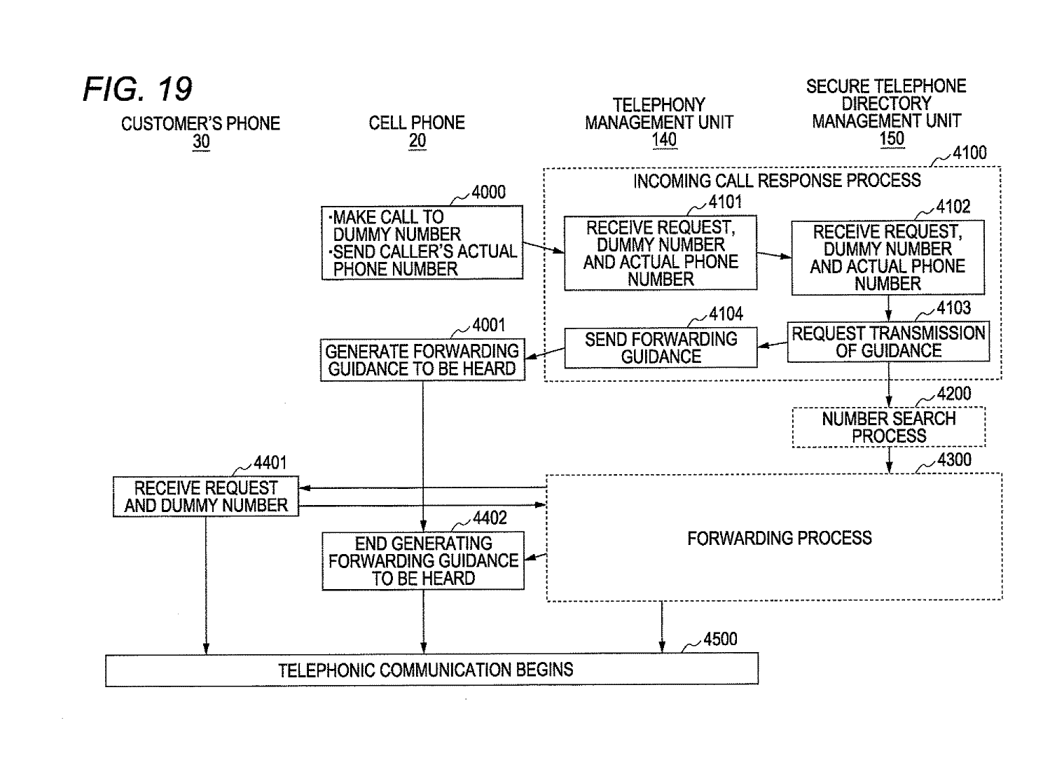

FIG. 19 to FIG. 21 show a processing flow from when a call is made to the callee of the dummy number, until when the call is connected to the customer's phone of the callee.

FIG. 19 is a workflow diagram starting from when a connection request specifying a dummy number as a connection destination is received by the secure telephone directory system 10, until when telephonic communication begins.

At process 4000, the user's cell phone 20 sends a connection request specifying a dummy number as the callee and specifying the actual number of the cell phone 20 as the caller.

When the secure telephone directory system 10 receives this connection request, it begins the process.

At process 4101, the telephony management unit 140 sends the connection request (callee=dummy number, caller=cell phone actual phone number) to the secure telephone directory management unit 150.

At process 4102, the secure telephone directory management unit 150 receives the connection request.

At process 4103, the secure telephone directory management unit 150 requests for transmission of guidance, and activates a number search process 4200.

At process 4104, the telephony management unit 140 sends forwarding guidance.

The forwarding guidance is sent to the cell phone 20.

At process 4001, the cell phone 20 generates this guidance to be heard.

As will specifically be described, a number search process 4200 of the secure telephone directory system 10 specifies the user based on the dummy number and the actual phone number of the cell phone 20, and searches for the actual phone number of the customer's phone 30 corresponding to the dummy number as a forwarding number. In a forwarding process 4300, a connection request specifying the forwarding phone number (actual phone number of the customer's phone 30) and the caller phone number (user number with “050”) acquired in the number search process 4200 is sent to the customer's phone 30.

When the customer's phone 30 receives the connection request specifying the user number with “050” as the caller, it begins the process.

At process 4401, the customer's phone 30 receives the connection request specifying the user number with “050” as the caller, and sends the response back to the secure telephone directory system 10.

Upon reception of the response from the customer's phone 30, the secure telephone directory system 10 stops sending the forwarding guidance.

At process 4402, the user's cell phone 20 stops generating the forwarding guidance to be heard.

At process 4500, the secure telephone directory system 10 connects a call between the customer's phone 30 as the caller and the user's cell phone 20 as the callee, thereby telephonic communication begins therebetween.

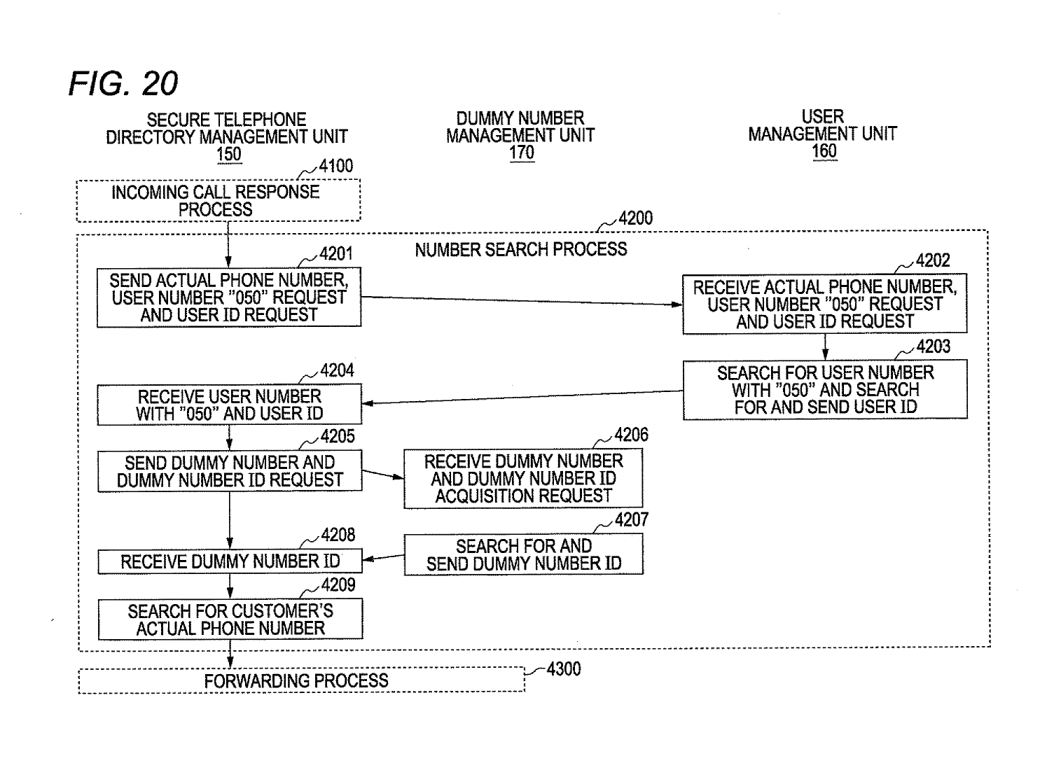

FIG. 20 is a workflow diagram specifically showing the number search process of FIG. 19.

Upon reception of a connection request from the incoming call response process 4100 (callee=dummy number, caller=actual phone number of the user's cell phone), the process begins.

At process 4201, the secure telephone directory management unit 150 sends a user number “050” request and a user ID request together with the actual phone number of the caller's phone number to the user management unit 160.

At process 4202, upon reception of the actual phone number of the user's cell phone, the user number “050” request and the user ID request, the user management unit 160 begins the process.

At process 4203, the user management unit 160 searches the user DB 11 based on the actual phone number of the user's cell phone to extract a user ID and user number with “050” corresponding to the user's actual phone number (forwarding number of the user information 110), and sends the extracted information to the secure telephone directory management unit 150.

At process 4204, the secure telephone directory management unit 150 receives the user ID and the user number with “050”.

At process 4205, the secure telephone directory management unit 150 sends the dummy number and the dummy number ID request to the dummy number management unit 170.

At process 4206, the dummy number management unit 170 receives the dummy number and the dummy number ID acquisition request.

At process 4207, the dummy number management unit 170 searches for and extracts a dummy number ID corresponding to the dummy number from the dummy number information stored in the dummy number DB 13, and sends the extracted ID to the secure telephone directory management unit 150.

At process 4208, the secure telephone directory management unit 150 receives the dummy number ID.

At process 4209, the secure telephone directory management unit 150 searches the secure telephone directory DB based on the user ID and the dummy number ID to extract the customer's actual phone number corresponding to this user ID and the dummy number ID. Then, the unit 150 activates the forwarding process 4300, and sends the extracted customer actual phone number and the user number with “050”.

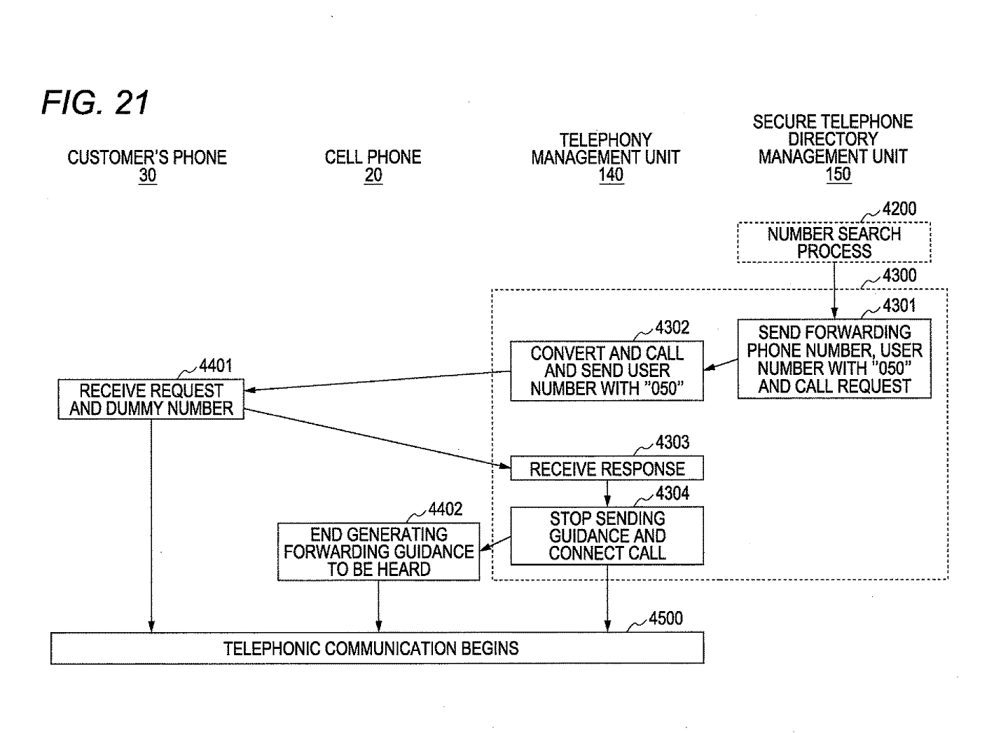

FIG. 21 is a workflow diagram specifically showing the forwarding process of FIG. 19.

Upon reception of the forwarding phone number (actual phone number of the customer's phone) and the user number with “050” from the secure telephone directory management unit 150, the process begins.

At process 4301, the secure telephone directory management unit 150 sends the forwarding phone number (the actual phone number of the customer's phone) and the user number with “050” acquired in the number search process 4200, to the telephony management unit 140, together with a call request.

At process 4302, the telephony management unit 140 converts the telephone number of the connection request based on the received forwarding phone number and the user number with “050”, and sends a connection request specifying the actual phone number of the customer's phone 30 as the callee and specifying the user number with “050” as the caller to the customer's phone 30.

Descriptions will now be made to the process of the customer's phone 30 which has received the connection request.

At process 4401, upon reception of the connection request specifying the user number with “050” as the caller, the customer's phone 30 sends the response back to the secure telephone directory system 10.

Descriptions will now be made to the process of the secure telephone directory system 10 which has received the response.

At process 4303, the telephony management unit 140 receives the response from the customer's phone 30.

At process 4304, the telephony management unit 140 stops sending the forwarding guidance which is being sent to the cell phone 20 as the caller, and connects a call between the cell phone 20 and the customer's phone 30.

At process 4402, since the forwarding guidance is no longer sent, the user's cell phone 20 ends generating the forwarding guidance to be heard.

At process 4500, the call is thus connected between the customer's phone 30 and the cell phone 20, thereby telephonic communication begin therebetween.

As a result of the above-discussed processes thus implemented, upon reception of the connection request specifying dummy number as the connection destination and the user's actual phone number as the caller, the secure telephone directory system 10 searches for the customer's actual phone number corresponding to the dummy number and the user number with “050”. Further, the system 10 converts information regarding the callee included in the connection request to the actual phone number of the customer's phone, and converts also information regarding the caller to the user number with “050”, and forwards the connection request after conversion to the customer's phone 30. Even if a dummy number is set as a destination number, the connection can be made to the requested destination, as long as it is the user's cell phone 20.

Descriptions will now be made to a call connection process performed when a dummy number specified as the connection destination is not registered in the secure telephone directory. In this case, it is not possible to search for the customer's actual phone number requested as the connection destination based on the dummy number. Thus, an error message representing the impossibility of the forwarding is sent, to the caller.

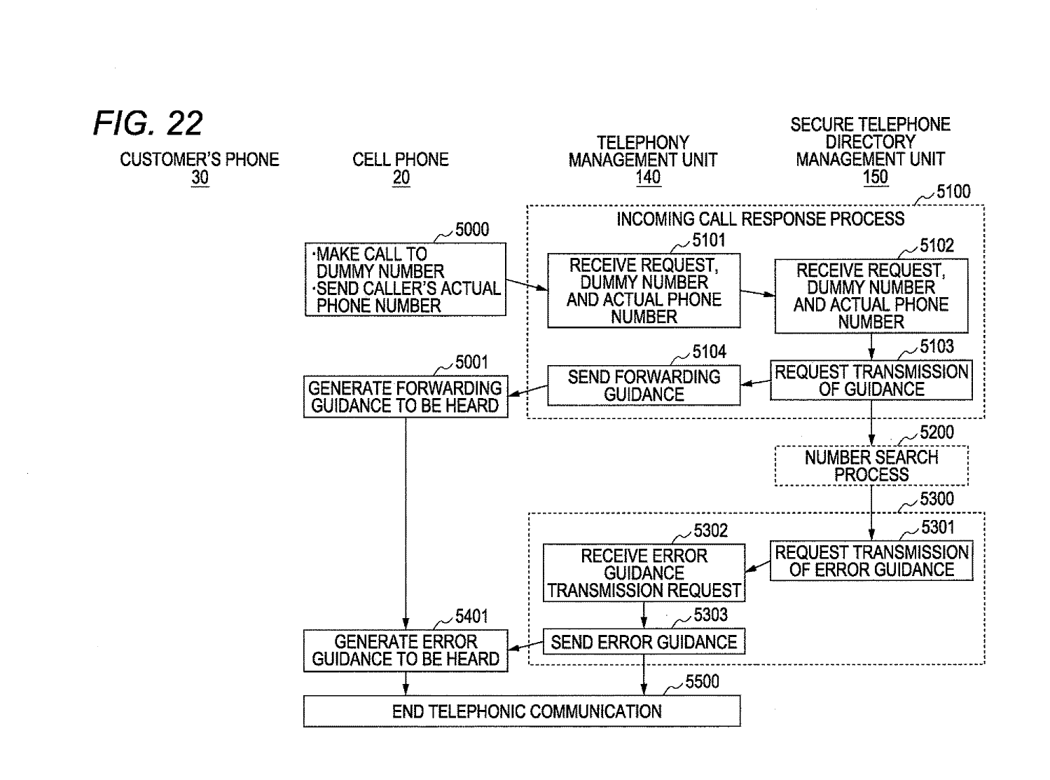

FIG. 22 is a workflow diagram when the dummy number of the callee is not registered in the secure telephone directory in FIG. 19.

At process 5000, the user's cell phone 20 makes a connection request specifying a dummy number as the callee and the actual number of the cell phone 20 as the caller.

Upon reception of this connection request, the secure telephone directory system 10 begins the process.

At process 5101, the telephony management unit 140 receives the request and sends a connection request (callee=dummy number, caller=user's actual phone number) to the secure telephone directory management unit 150.

At process 5102, the secure telephone directory management unit 150 receives the connection request.

At process 5103, the secure telephone directory management unit 150 requests for transmission of the guidance, and activates a number search process 5200.

At process 5104, the telephony management unit 140 sends the forwarding guidance.

The forwarding guidance is sent to the user's cell phone 20.

At process 5001, the user's cell phone 20 generates this guidance to be heard.

As will specifically be described later, assume that an error message representing that the actual phone number of the customer's phone 30 corresponding to the dummy number could not successfully be detected is sent in a number search process 5200.

In a forwarding process 5300, the error message representing that the actual phone number of the callee could not be acquired is acquired, and the process begins.

At process 5301, the secure telephone directory management unit 150 acquires the error message representing that the actual phone number of the caller could not be acquired, and requests the telephony management unit 140 to send error guidance.

At process 5302, the telephony management unit 140 receives the error guidance transmission request.

At process 5303, the telephony management unit 140 sends error guidance to the user's cell phone 20 of the caller.

The error guidance sent from the secure telephone directory system 10 received by the cell phone 20.

At process 5401 the cell phone 20 generates the error guidance representing that a connection cannot be made to the callee to be heard.

At process 5500, the communication ends.

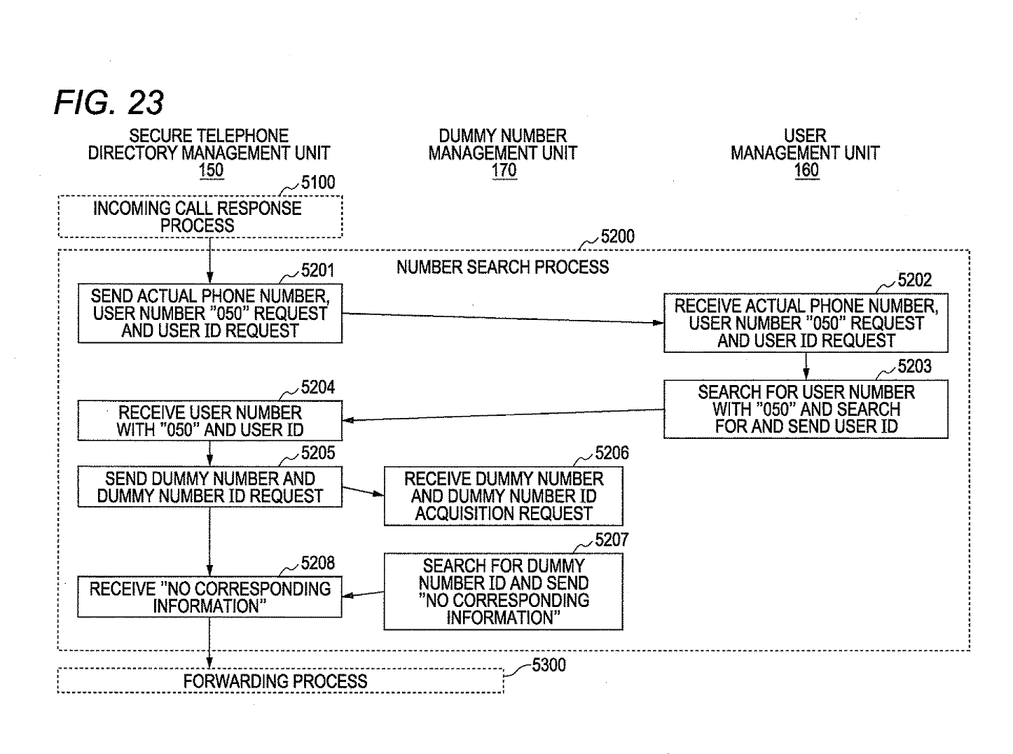

FIG. 23 is a workflow diagram specifically showing the number search process of FIG. 22.

Upon reception of a connection request (callee=dummy number, caller=actual phone number of the user's cell phone) from an incoming call response process 5100, the process begins.

At process 5201, the secure telephone directory management unit 150 sends a user number “050” request and a user ID request to the user management unit 160, together with an actual phone number of the caller's cell phone.

At process 5202, upon reception of the actual phone number of the user's cell phone, the user number “050” request and the user ID request, the user management unit 160 begins the process.

At process 5203, the user management unit 160 searches the user DB 11 based on the actual phone number of the user's cell phone to extract a user ID and a user number with “050” corresponding to the user's actual phone number (forwarding number of the user information 110), and sends the extracted information to the secure telephone directory management unit 150.

At process 5204, the secure telephone directory management unit 150 receives the user ID and the user number with “050”.

At process 5205, the secure telephone directory management unit 150 sends a dummy number and a dummy number ID request to the dummy number management unit 170.

At process 5206, the dummy number management unit 170 receives the dummy number and the dummy number ID request.

At process 5207, the dummy number management unit 170 searches the dummy number information stored in the dummy number DB 13. However, since a corresponding dummy number is not detected, the unit sends information representing that there is no corresponding dummy number to the secure telephone management unit 150.

At process 5208, the secure telephone directory management unit 150 receives the information representing that there is no corresponding dummy number. The unit 150 cannot specify the callee, because the dummy number was not detected. Therefore the unit 150 activates the forwarding process 5300, and sends an error message that the actual phone number of the callee cannot be acquired.

The following processes are the same as those shown in FIG. 22, thus will not be explained here.

As a result of the above-identified processes thus implemented, when the dummy number of the callee is not detected, the forwarding process is stopped, because the forwarding number cannot be specified.

Descriptions will now be made to the case where a connection request specifying a dummy number as the connection destination is sent from a telephone other than the user's telephone. In this case, because the user cannot be specified, an error process is implemented.

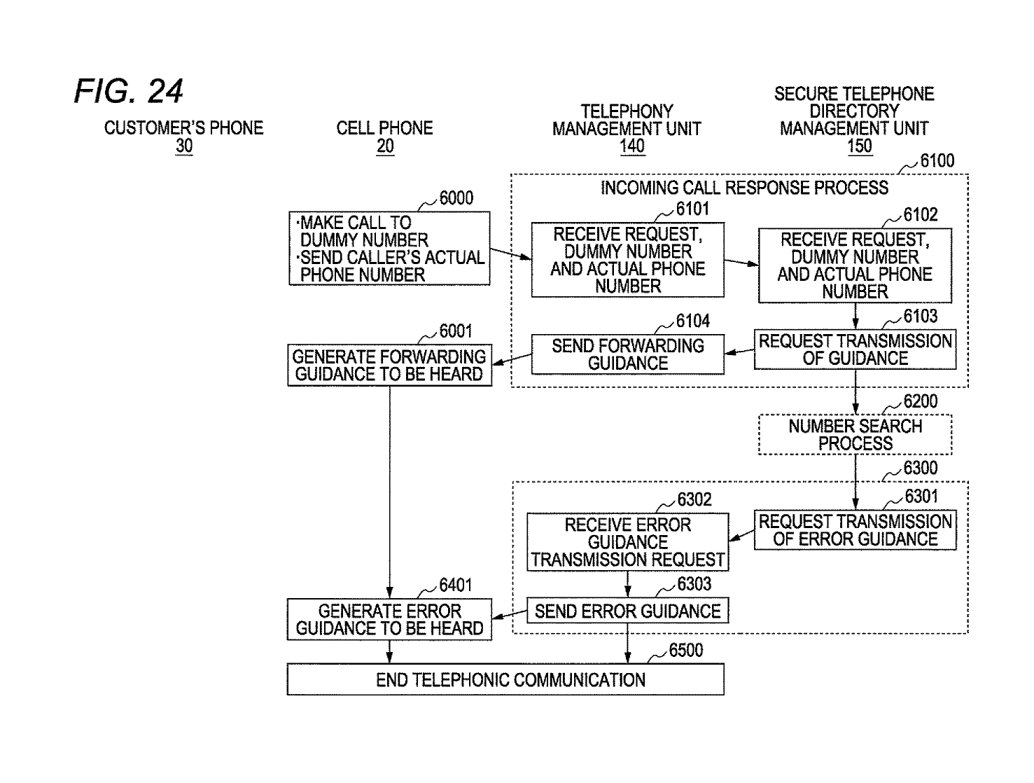

FIG. 24 is a workflow diagram when a dummy number of the callee is not registered in the secure telephone directory in FIG. 19.

At process 6000, the user's cell phone 20 sends a connection request specifying a dummy number as the callee and an actual phone number of the cell phone 20 as the caller.

At process 6101, the telephony management unit 140 receives the request and sends a connection request (callee=dummy number, caller=user's actual phone number) to the secure telephone directory management unit 150.

At process 6102, the secure telephone directory management unit 150 receives the connection request.

At process 6103, the secure telephone directory management unit 150 requests for transmission of guidance, and activates a number search process 6200.

At process 6104, the telephony management unit 140 sends forwarding guidance.

The forwarding guidance is sent to the user's cell phone 20.

At process 6001, rhe user's cell phone 20 generates this guidance to be heard.

As will specifically be described below, assume that an error message representing that the user cannot successfully be detected, that is the caller is not a proper user, is sent from in the number search process 6200.

Upon reception of the error message that the caller is not a proper user, a forwarding process 6300 begins the process.

At process 6301, the secure telephone directory management unit 150 acquires the error message that the caller is not a proper user, and requests the telephony management unit 140 to send error guidance

At process 6302, rhe telephony management unit 140 receives the error guidance transmission request.

At process 6303, rhe telephony management unit 140 sends the error guidance to the user's cell phone 20 of the caller.

The error guidance sent from the secure telephone directory system 10 received by the cell phone 20.

At process 6401, the cell phone 20 generates the error guidance representing that a call cannot be connected to the callee to be heard.

At process 6500, the communication ends.

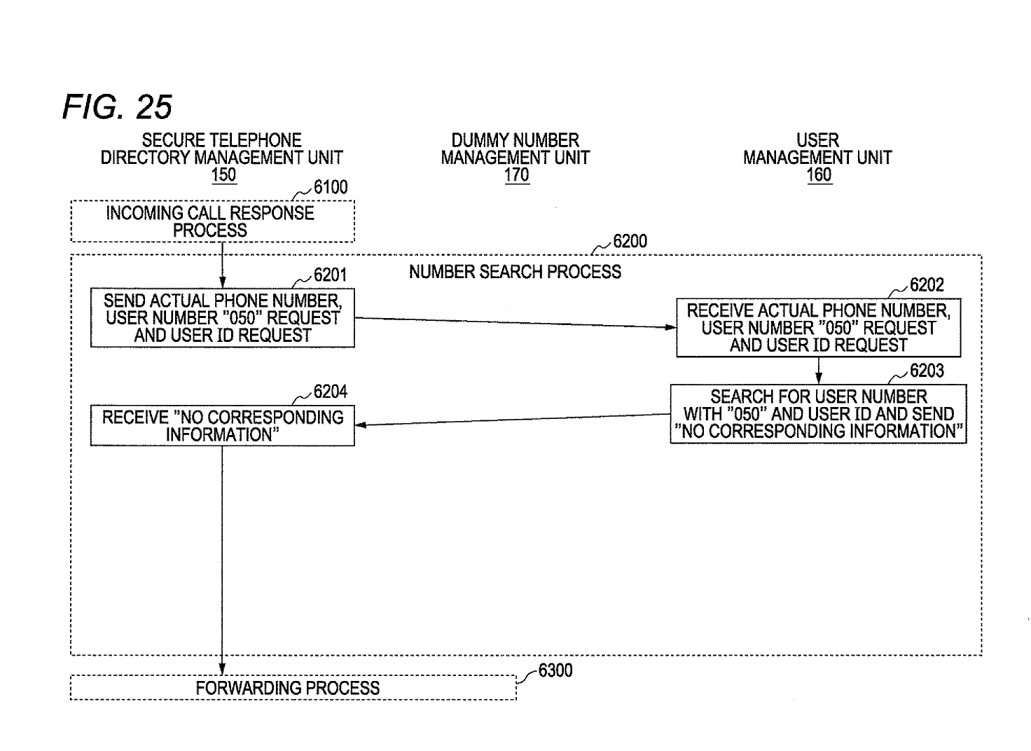

FIG. 25 is a workflow diagram specifically showing the number search process of FIG. 24.

Upon reception of a connection request (callee=dummy number, caller=actual number of user's cell phone) from an incoming call response process 6100, the process is begins.

At process 6201, the secure telephone directory management unit 150 sends a user number “050” request and a user ID request to the user management unit 160, together with the actual phone number of the caller's cell phone.

At process 6202, upon reception of the actual phone number of the user's cell phone, the user number “050” request and the user ID request, the user management unit 160 begins the process.

At process 6203, the user management unit 160 searches the user DB 11 based on the actual phone number of the user's cell phone to extract a user ID and a user number with “050” corresponding to the user's actual phone number (forwarding number of the user information 110), however, the information cannot be detected. Therefore, the unit 160 sends information representing that there is no corresponding information to the secure telephone directory management unit 150.

At process 6204, the secure telephone directory management unit 150 receives the information representing that there is no corresponding information. The unit 150 then activates the forwarding process 6300, and sends an error message representing that the caller is not a proper user.

The following processes are the same as those shown in FIG. 24, and thus will not be described here.

As a result that the above processes are executed, when the caller is not a proper user, the forwarding process is stopped.

According to an embodiment of the present invention, leakage of personal information can be prevented in various supposable cases.

Descriptions will now be made to a registration process for the secure telephone directory. As shown in the entire configuration of the system, to register information in the secure telephone directory, the user's cell phone 20 or user PC 22 is connected with the data network 52 to access the secure telephone directory management server 15.

Descriptions will now be made to a registration screen displayed on the cell phone 20 or user PC 22.

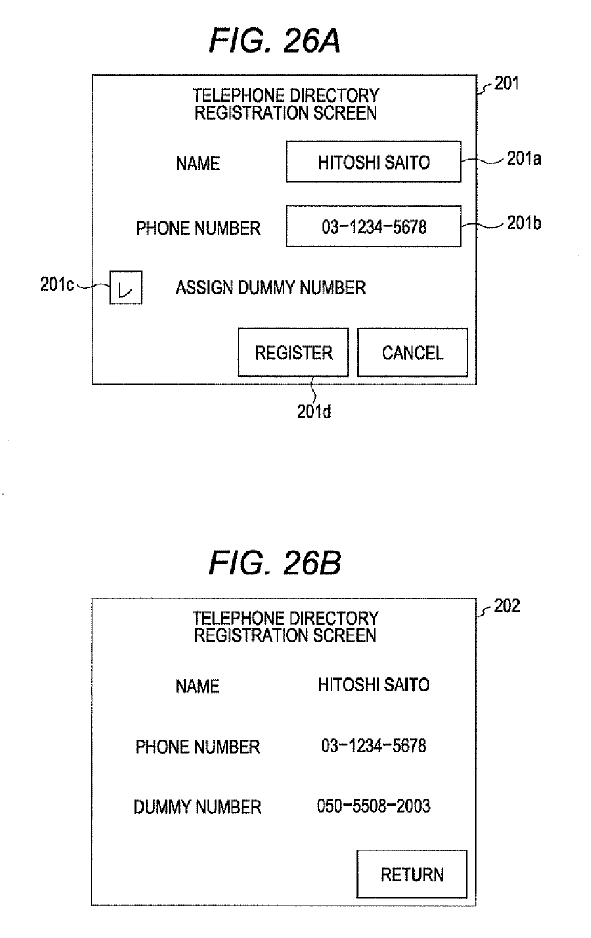

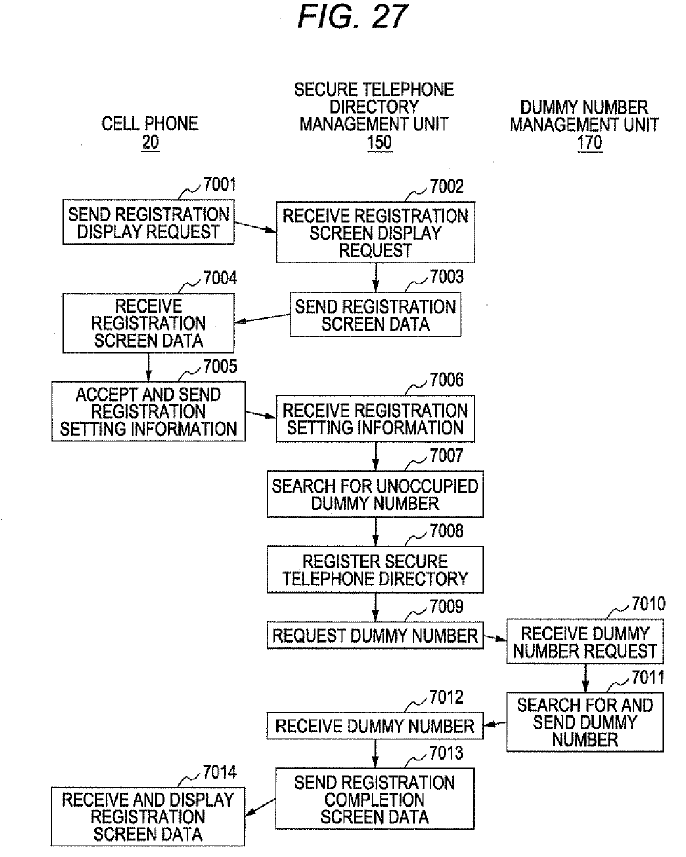

FIG. 26A and FIG. 26B are diagrams each showing an example of a secure telephone directory registration screen of an embodiment of the present invention. FIG. 26A shows a telephone directory initial registration screen, while FIG. 26B shows a telephone directory registration completion screen.

A telephone directory initial registration screen 201 has an entry field 201a for a customer name to be registered, and an entry field 201b for a phone number. The user inputs a desired customer name and phone number to be registered, in the respective fields.

The user sets a selection field 201c for specifying whether to set a dummy number. When the user sets a dummy number to be assigned thereto and operates a “register” button 201d, a dummy number is assigned to the customer. In addition, telephone directory information regarding the customer input as a target to be registered (actual phone number, user ID, customer name, dummy number ID) is stored in the secure telephone directory DB 12. Assume that the user ID is set by the user in a login process implemented before activation of the telephone directory registration screen. When the user does not set a dummy number for the customer, “null” is set and registered in the dummy number ID of the telephone directory.

The telephone directory initial registration screen 201 then shifts to the telephone directory registration completion screen 202. The telephone directory registration completion screen 202 displays an assigned dummy number.

This information (dummy number, name) is registered in the cell phone directory of the cell phone 20.

Descriptions will now be made to processing procedures for registering information in the secure telephone directory. In the descriptions below, the registration is implemented using the cell phone.

FIG. 27 is a workflow diagram showing procedures of a secure telephone directory registering process of an embodiment of the present invention.

The user's cell phone 20 logs into the secure telephone directory management unit 150, thereby beginning the process.

At process 7001, the cell phone 20 issues a registration screen display request for registering information in the secure telephone directory.

At process 7002, the secure telephone directory management unit 150 receives the registration screen display request from the cell phone 20.

At process 7003, the secure telephone directory management unit 150 sends registration screen data for displaying the registration screen on the cell phone 20. The registration screen data is sent to the cell phone 20 through the data network 52.

At process 7004, the cell phone 20 receives the registration screen data, and displays, based on the data, a display screen having all blank entry fields on its display unit, as the telephone directory initial registration screen 201 shown in FIG. 26A.

At process 7005, the cell phone 20 waits for the user to input data into: the entry field 201a for the customer name; the entry field 201b for the telephone number and the flag 201c for acquiring a dummy number, on the registration screen. Upon user operation and inputting of the data, the cell phone 20 sends the input data (registration setting information) to the secure telephone directory management unit 150. In this case, the cell phone sends the customer name and telephone number to be registered and also the dummy number acquisition flag, together with the user ID.

At process 7006, the secure telephone directory management unit 150 receives the input data (registration setting information) sent from the cell phone 20.

At process 7007, the secure telephone directory management unit 150 searches for an unoccupied dummy number ID for each user ID, if the dummy number acquisition flag is “acquire”. That is, the unit 150 searches the secure telephone directory DB 12 using the user ID, and searches for a non-given dummy number ID for the same user ID registered in the secure telephone directory.

At process 7008, the secure telephone directory management unit 150 assigns the dummy number ID searched in a process 7007 to a target customer to be registered this time, and registers the data in the secure telephone directory together with the acquired customer name and phone number, in association with its user ID. When the dummy number is not acquired, “null” is registered in the dummy number.

At process 7009, the secure telephone directory management unit 150 specifies the dummy number ID, and requests the dummy number management unit 170 for a corresponding dummy number.

At process 7010, the dummy number management unit 170 receives the dummy number request from the secure telephone directory management unit 150, together with the dummy number ID.

At process 7011, the dummy number management unit 170 searches the dummy number DB 13 based on the dummy number ID received in a process 7010 to extract its corresponding dummy number. The extracted dummy number is sent to the secure telephone directory management unit 150.

At process 7012, the secure telephone directory management unit 150 receives the dummy number corresponding to the dummy number ID from the dummy number management unit 170.

At process 7013, the secure telephone directory management unit 150 sends registration screen data for displaying the registration completion screen 202 shown in FIG. 26B on the cell phone 20 to the cell phone 20, using the acquired dummy number.

At process 7014, the cell phone 20 receives the registration screen data sent by the secure telephone directory management unit 150, and displays the registration completion screen 202 on the display unit based on the received data.

As a result of the above processes, the security telephone directory can be registered.

Descriptions will now be made to a process for registering a cell phone directory in the cell phone 20.

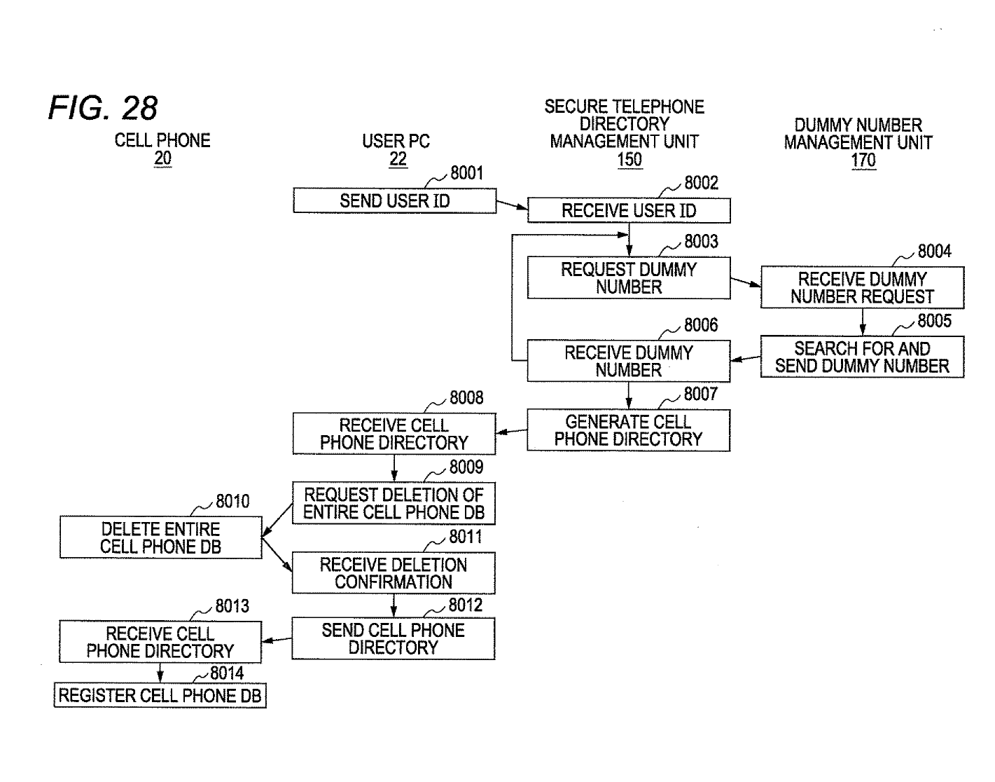

FIG. 28 is a workflow diagram showing procedure(s) of a cell phone directory setting process of an embodiment of the present invention. Descriptions will now be made to the case where the telephone directory is downloaded to the cell phone through the user PC 22. The user PC 22 includes cell phone cooperative software for operating the cell phone 20.

At process 8001, the user PC 22 sends a user ID of the secure telephone directory to be downloaded to the secure telephone directory management unit 150.

At process 8002, the secure telephone directory management unit 150 receives the user ID.

At process 8003, the secure telephone directory management unit 150 searches the secure telephone directory DB 12 based on the user ID to extract a record corresponding to the user ID. Then, the unit 150 then sends a dummy number ID included in the record and a dummy number request to the dummy number management unit 170.

At process 8004, the dummy number management unit 170 receives the dummy number ID and the dummy number request.

At process 8005, the dummy number management unit 170 searches the dummy number DB 13 based on the dummy number ID to extract a dummy number corresponding to the dummy number ID. The unit 170 sends the extracted dummy number to the security telephone directory management unit 150.

At process 8006, the security telephone directory management unit 150 receives the dummy number.

Those processes 8003, and 8006 are repeated until all the records are completely processed. As a result, the secure telephone directory management unit 150 can acquire the dummy numbers of all records corresponding to the specified user IDs.

At process 8007, the security telephone directory management unit 150 generates a cell phone directory storing the acquired dummy number and the customer name in association with each other, and sends the generated directory to the user PC.

At process 8008, the user PC 22 receives the cell phone directory from the secure telephone directory management unit 150.

At process 8009, the user PC 22 sends an entire deletion request to the cell phone 20 for deleting the cell phone DB entirely.

At process 8010, upon reception of the entire deletion request for deleting the cell phone DB from the user PC 22, the cell phone 20 deletes the entire data of the cell phone directory DB 21, and sends a deletion confirmation response to the user PC.

At process 8011, the user PC 22 receives the deletion confirmation response from the cell phone 20.

At process 8012, the user PC 22 sends the cell phone directory received in the process 8008 to the cell phone 20.

At process 8013, the cell phone 20 receives the cell phone directory from the user PC 22.

At process 8014, the cell phone 20 writes and registers the received cell phone directory into the cell phone DB 21.

As a result of the above processes, a directory of a cell phone can be set in accordance with simple operations. Thus, the cell phone user can make confirm information of the callee of the connection request which is received through the secure telephone directory system 10, before the call connection is made.

In the above descriptions of embodiment(s), it has been assumed that the information stored in the cell phone may possibly be leaked. However, the present invention is not limited to this. If the telephone directory recorded in a fixed telephone, or if a dummy number is recorded on a telephone directory printed on a sheet of paper, the information can be protected from a malicious third party like the case of the cell phone.

The above processing functions can be realized by a computer. In such a case, the computer is provided with programs describing the processing contents of the functions to be included in the call connector. When the programs are executed by the computer, the processing functions can be realized thereon. The programs describing the processing contents can be recorded on a computer readable recording medium. The computer readable recording medium may be a magnetic storage unit, an optical disk, an optical magnetic recording medium or a semiconductor memory. The magnetic storage unit may be a hard disk drive (HDD), a flexible disk (FD) or a magnetic tape. The optical disk may be a DVD (Digital Versatile Disc), a DVD-RAM (Random Access Memory), a CD-ROM (Compact Disc Read Only Memory) or a CD-R (Recordable)/RW (ReWritable), etc. The optical magnetic recording medium may be an MO (Magneto-Optical Disk), etc.

When the programs are distributed, portable recording medium such as DVD and CD-ROM. on which the programs are stored are sold. The programs can be stored in a storage unit of a server computer, and can be forwarded from the server computer to another computer through a network.

The computer executing the programs stores, for example, the programs stored on the portable recording medium or programs forwarded from the server computer, in its own storage unit. The computer reads the programs from its own storage unit to execute processes in accordance with the programs. Note that the computer can read the programs directly from the portable recording medium to execute processes in accordance with the programs. The computer also can execute processes successively in accordance with the received programs, each time a program is forwarded from the server computer.

Although a few embodiments have been shown and described, it would be appreciated by those skilled in the art that changes may be made in these embodiments without departing from the principles and spirit of the invention, the scope of which is defined in the claims and their equivalents.

What is claimed is:

1. A computer-readable recording medium storing a call connection program causing a computer to execute operations including controlling a call connection between a telephone of a connection service user and a telephone of a registered number registered by a user as a number for telephonic communication, comprising:
searching for user information including a user connection number, user identification information identifying the user and an actual phone number directly connecting to the telephone of the user, stored in association with each other;
extracting the user identification information corresponding to the user connection number and the actual phone number of the user, based on the user connection number, upon acquisition of a call connection request specifying the actual phone number for directly connecting to the telephone of the registered telephone number as a caller's phone number and specifying the user connection number for connecting to the telephone of the user through the connection service as a phone number of a connection request destination;
searching for telephone directory information including the actual phone number of the registered number and a dummy number assigned to the actual phone number of the registered number stored in association with the user identification information and extracting the dummy number of the registered number, based on the user identification information extracted and the actual phone number of the registered number of the caller; and
forwarding the call connection request, to the telephone of the user, including specifying the actual phone number of the user extracted as a forwarding number and the dummy number of the registered number extracted as a caller.

2. The recording medium storing the call connection program, according to claim 1, wherein:
the dummy number is stored in a dummy number storage unit in association with dummy number specification information specifying the dummy number; and
the dummy number specification information is set in the telephone directory information instead of the dummy number, the dummy number specification information corresponding to the registered number is read from the telephone directory information when the dummy number assigned to the registered number is needed, the dummy number storage unit is searched based on the dummy number specification information read to extract the dummy number corresponding to the dummy number specification information set for the registered number.

3. The recording medium storing the call connection program, according to claim 2, wherein
different dummy number specification information specifying different dummy numbers are assigned to numbers registered by the user and correspond to identification information of the user, while same dummy number specification information are assigned to users corresponding to different user identification information.

4. The recording medium storing the call connection program, according to claim 1, wherein
a predetermined default phone number is set as a number of the caller, when the dummy number has not been detected.

5. The recording medium storing the call connection program, according to claim 1, wherein
a predetermined default phone number is set as a number of the caller, when the actual phone number of the registered number of the caller has not been acquired.

6. The recording medium storing the call connection program, according to claim 1, wherein:
identification information of the user is extracted based on the actual phone number of the user and the user connection number of the user, upon reception of a connection request specifying the dummy number as a phone number of the connection request destination, if the phone number of the caller of the connection request received is the actual phone number of the user;
the telephone directory information is searched based on the user identification information and the dummy number set for the caller of the connection request to extract an actual phone number of the registered number corresponding to the user identification information and the dummy number; and
the call connection request is forwarded to the telephone of the registered number, and the request specifies the actual phone number of the registered number extracted as a callee and the user connection number as a caller.

7. The recording medium storing the call connection program, according to claim 6, wherein
an error guidance is sent to the caller of the connection request to end the call connection, when the actual phone number of the registered number corresponding to the user identification information and the dummy has not been detected.

8. The recording medium storing the call connection program, according to claim 6, wherein
an error guidance is sent to the caller of the connection request to end the call connection, if the phone number of the caller of the connection request destination is not the actual phone number of the user.

9. A call connection method executed by a computer which controls a call connection between a telephone of a connection service user and a telephone of a registered number registered by a user as a destination number for telephonic communication, the method comprising:
searching for user information including a user connection number, user identification information identifying the user and an actual phone number directly connecting to the telephone of the user, stored in association with each other,
extracting the user identification information corresponding to the user connection number and the actual phone number of the user, based on the user connection number upon acquisition of a call connection request specifying the actual phone number for directly connecting to the telephone of the registered telephone number as a caller's phone number and specifying the user connection number for connecting to the telephone of the user through the connection service as a phone number of a connection request destination;
searching for telephone directory information including the actual phone number of the registered number and a dummy number assigned to the actual phone number of the registered number stored in association with the user identification information and extracting the dummy number of the registered number, based on the user identification information extracted and the actual phone number of the registered number of the caller; and
forwarding the call connection request to the telephone of the user, the request specifying the actual phone number of the user extracted as a forwarding number and the dummy number of the registered number extracted as a caller.

10. A call connector which controls a call connection between a telephone of a connection service user and a telephone of a registered number registered by a user as a number for telephonic communication, the connector comprising:
user information storage means for storing user information including user identification information for identifying the user, an actual phone number for directly connecting to the telephone of the user and a user connection number for connecting to the telephone of the user through the connection service, in association with each other;
telephone directory storage means for storing a telephone directory including an actual phone number for directly connecting to the telephone of the registered number and a dummy number assigned to the actual phone number of the registered number in association with the user identification information;
user identification means for searching for the user information based on the user connection number extracting the user identification information corresponding to the user connection number and the actual phone number of the user, upon acquisition of a call connection request specifying the actual phone number of the registered number as a caller's phone number and specifying the user connection number as a phone number of a connection request destination;
phone number search means for searching for the telephone directory information based on the user identification information extracted by the user identification means and the actual phone number of the registered number of the caller and extracting a dummy number of the registered number; and
forwarding processing means for forwarding the call connection request to the telephone of the user, the request specifying the actual phone number of the user extracted by the user identification means as a forwarding number and specifying the dummy number of the registered number extracted by the phone number search means as a caller.

11. A telephone for making a call connection with a call connector for controlling a call connection between a telephone of a connection service user and a telephone of a registered number registered by a user as a number for telephonic communication, the telephone comprising:
a telephone directory acquisition unit storing an actual phone number directly connecting to the telephone of the registered number, a dummy number assigned to the telephone of the registered number and a display name assigned to the registered number, and acquiring a telephone directory storing the dummy number and the display name corresponding to the dummy number in association with each other from the call connector which converts a caller of a connection request to the dummy number assigned to the registered number and forwards the number to the unit upon reception of the connection request from the registered number;
a telephone directory storage unit storing the telephone directory acquired by the telephone directory acquisition unit;
a search unit searching the telephone directory of the telephone directory storage unit based on the dummy number of the connection request and extracting a display name corresponding to the dummy number, when the caller receives a connection request for the dummy number as the caller from the call connector; and
a display unit displaying the display name searched by the search unit on a display screen.
